(19) United States
(12) Patent Application Publication
(10) Pub. No.: US 2025/0157055 A1
(43) Pub. Date: May 15, 2025

(54) METHOD AND APPARATUS WITH SCENE FLOW ESTIMATION

(71) Applicant: Samsung Electronics Co., Ltd., Suwon-si (KR)

(72) Inventors: Xiongfeng PENG, Beijing (CN); Zhihua LIU, Beijing (CN); Qiang WANG, Beijing (CN); Soon-Yong CHO, Suwon-si (KR)

(73) Assignee: Samsung Electronics Co., Ltd., Suwon-si (KR)

(21) Appl. No.: 18/944,556

(22) Filed: Nov. 12, 2024

(30) Foreign Application Priority Data
Nov. 15, 2023 (CN) 202311527401.8
Sep. 3, 2024 (KR) 10-2024-0119364

(51) Int. Cl. G06T 7/246; G06T 7/215; G06V 10/74; G06V 10/764; G06V 10/77; G06V 10/776; G06V 10/82; G06V 20/70

(52) U.S. Cl. CPC G06T 7/248; G06T 7/215; G06V 10/761; G06V 10/764; G06V 10/7715; G06V 10/776; G06V 10/82; G06V 20/70; G06T 2207/10024; G06T 2207/10028; G06T 2207/20081; G06T 2207/20084

(57) ABSTRACT

A scene flow estimation method includes: inputting a frame pair into an artificial intelligence (AI) network, and obtaining therefrom a motion embedding feature and a non-occluded-category label embedding feature corresponding to a target pixel in the frame pair; and estimating a scene flow corresponding to the frame pair based on the motion embedding feature and the non-occluded-category label embedding feature, the frame pair includes a first frame and a second frame, the first frame including a first color image and a first depth image and the second frame including a second color image and a second depth image, the non-occluded-category label embedding feature includes category information of an object corresponding to a pixel pair in the frame pair, the pixel pair includes a first pixel of the first frame and a second pixel of the second frame, and the second pixel corresponds to the first pixel.

### CROSS-REFERENCE TO RELATED APPLICATIONS

This application claims the benefit under 35 USC § 119(a) of Chinese Patent Application No. 202311527401.8 filed on Nov. 15, 2023, in the China National Intellectual Property Administration, and Korean Patent Application No. 10-2024-0119364 filed on Sep. 3, 2024, in the Korean Intellectual Property Office, the entire disclosures of which are incorporated herein by reference for all purposes.

### BACKGROUND

### 1. Field

The following description relates to image processing and artificial intelligence (AI) and, more particularly, to scene flow estimation.

### 2. Description of Related Art

A scene flow represents point-wise movements between two image frames. A scene flow may be found by interpreting how each pixel in an image frame changes in two successive frames. A scene flow may be used to estimate three-dimensional (3D) structures and 3D motions of parts of a scene that is often complex and changing. The scene can potentially include static objects, dynamic objects, rigid objects, non-rigid objects, strongly textured regions, weakly textured regions, non-occluded region, and occluded regions, any of which can affect the accuracy of a computed scene flow.

Scene flow is used in various fields such as, robotics, augmented reality (AR), and autonomous vehicles. A scene flow represents pixel-level phenomena. In scene flow, various estimations may be effective in scene understanding operations, such as, for example, object detection, object tracking, object segmentation, and object pose estimation. In scene flow technology, improving estimation performance may be of core technical concern to a person of ordinary skill in the art.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a processor-implemented scene flow estimation method includes: inputting a frame pair into an artificial intelligence (AI) network, and obtaining therefrom a motion embedding feature and a non-occluded-category label embedding feature corresponding to a target pixel in the frame pair; and estimating a scene flow corresponding to the frame pair based on the motion embedding feature and the non-occluded-category label embedding feature, wherein the frame pair includes a first frame and a second frame, wherein the first frame includes a first color image and a first depth image and the second frame includes a second color image and a second depth image, wherein the non-occluded-category label embedding feature includes category information of an object corresponding to a pixel pair in the frame pair, wherein the pixel pair includes a first pixel of the first frame and a second pixel of the second frame, the second pixel corresponding to the first pixel.

The estimating of the scene flow corresponding to the frame pair may include: obtaining a motion field corresponding to the frame pair; obtaining the motion embedding feature and the non-occluded-category label embedding feature by inputting the motion field into the AI network; fusing the motion embedding feature with the non-occluded-category label embedding feature to obtain a fused embedding feature; obtaining a target motion field by updating the motion field based on the fused embedding feature; and estimating the scene flow corresponding to the frame pair based on the target motion field.

The obtaining of the target motion field may include: determining a neighboring point set including pixels in the second frame that correspond to a target pixel in the first frame; determining a matching level between the target pixel and the pixels in the neighboring point set, based on a fused embedding feature corresponding to the target pixel and based on fused embedding features of the respective pixels in the neighboring point set; and obtaining the target motion field by updating the motion field based on the matching level.

The estimating of the scene flow corresponding to the frame pair may include: obtaining a weight that adjusts the motion field, based on similarity levels of similarity between pixels of the first color image; and estimating the scene flow corresponding to the frame pair, based on the target motion field obtained by applying the weight to the motion field.

The obtaining of the weight may include: obtaining a first correlation between the pixels of the first color image by inputting the first color image into an attention encoder of the AI network; and determining a first weight corresponding to the first color image based on the first correlation.

The obtaining of the weight may include: obtaining a second correlation between pixels of the second color image by inputting the color image included in the second frame into the attention encoder; determining a second weight corresponding to the second color image based on the second correlation; and obtaining a fused weight that adjusts the motion field by fusing the first weight with the second weight.

The obtaining of the motion embedding feature and the non-occluded-category label embedding feature may include: extracting, based on a feature encoder included in the AI network, a first frame feature from the first frame and a second frame feature from the second frame; generating a correlation volume corresponding to the frame pair, based on a correlation between the first frame feature and the second frame feature; extracting, based on a context encoder included in the AI network, a context feature and a hidden state corresponding to the first frame from the first frame data; and obtaining the motion embedding feature and the non-occluded-category label embedding feature, by an operation of a convolutional gated recurrent unit (CGRU)-based update network included in the AI network, the operation based on the context feature, the hidden state, the motion field, and the correlation volume.

The scene flow estimation method may further include: training the AI network by iteratively performing a training operation on the AI network with a training set until a training end condition is satisfied.

The training set may include a sample frame pair, and a ground truth (GT) scene flow value and a GT non-occluded-category label mask value corresponding to the sample frame pair, wherein sample frame pair includes a first sample frame including a first sample color image and a first sample depth image, and further includes a second sample frame including a second sample color image and a second sample depth image, the GT non-occluded-category label mask value may include category information corresponding to a sample pixel pair in the sample frame pair, and the sample pixel pair may include a first sample pixel in the first sample frame and a second sample pixel in the second sample frame, the first sample pixel corresponding to the second sample pixel.

The training of the AI network by iteratively performing the training operation may include: obtaining a sample motion embedding feature and a sample non-occluded-category label embedding feature corresponding to the sample frame pair by applying the AI network to be trained to the sample frame pair; obtaining an estimated scene flow value corresponding to the sample frame pair, based on the sample motion embedding feature and the sample non-occluded-category label embedding feature; obtaining an estimated non-occluded-category label mask value corresponding to the sample frame pair, based on the sample non-occluded-category label embedding feature; determining a first training loss, based on the predetermined GT scene flow value and the estimated scene flow value corresponding to the sample frame pair; determining a second training loss, based on the predetermined GT non-occluded-category label mask value and the estimated non-occluded-category label mask value corresponding to the sample frame pair; determining a combined training loss based on the first training loss and the second training loss; and adjusting a model parameter of the AI network to be trained, based on the combined training loss.

The obtaining of the estimated non-occluded-category label mask value corresponding to the sample frame pair, based on the sample non-occluded-category label embedding feature, may include: determining an average non-occluded-category label feature of pixels corresponding to a category included in the sample frame pair, based on the GT non-occluded-category label mask value and the sample non-occluded-category label embedding feature; and based on a difference between a sample non-occluded-category label embedding feature corresponding to a pixel included in the first sample frame and an average non-occluded-category label feature of pixels corresponding to a category to which the pixel included in the first sample frame belongs, obtaining the estimated non-occluded-category label mask value corresponding to the category of the pixel included in the first sample frame data.

The GT non-occluded-category label mask value corresponding to the sample frame pair may be determined based on: obtaining an object instance segmentation result for object instances included in the sample frame pair; determining a first optical error between matched pixels of a pixel pair in the sample frame pair, based on the GT scene flow value corresponding to the sample frame pair; determining a GT non-occluded-category label mask value corresponding to each of the object instances included in the sample frame pair, based on the first optical error and the object instance segmentation result; and obtaining the GT non-occluded-category label mask value corresponding to the sample frame pair, based on the GT non-occluded-category label mask value corresponding to each of the object instances included in the sample frame pair.

The GT non-occluded-category label mask value corresponding to the sample frame pair may be determined based on: obtaining a GT motion field value corresponding to the sample frame pair; determining a second optical error and a depth error between the matched pixels of the pixel pair in the sample frame pair, based on the GT motion field value; determining a GT non-occluded-category label mask value corresponding to a non-occluded background region of the sample frame pair, based on the second optical error and the depth error; and obtaining the GT non-occluded-category label mask value corresponding to the sample frame pair by fusing the GT non-occluded-category label mask value corresponding to the non-occluded background region and the GT non-occluded-category label mask value corresponding to each of the object instances included in the sample frame pair.

A non-transitory computer-readable storage medium may store instructions that, when executed by a processor, cause the processor to perform any of the the scene flow estimation methods.

In another general aspect, a scene flow estimation device includes: one or more processors configured to input a frame pair into an artificial intelligence (AI) network and obtain a motion embedding feature and a non-occluded-category label embedding feature corresponding to the frame pair, and estimate a scene flow corresponding to the frame pair based on the motion embedding feature and the non-occluded-category label embedding feature, wherein the frame pair includes a first frame and a second frame, the first frame including a first color image and a first depth image, and the second frame including a second color image and a second depth image, wherein the non-occluded-category label embedding feature includes category information of an object corresponding to a pixel pair in the frame pair, wherein the pixel pair includes a first pixel of the first frame and a second pixel of the second frame, the first pixel corresponding to the second pixel.

The one or more processors may be further configured to: obtain a motion field corresponding to the frame pair; obtain the motion embedding feature and the non-occluded-category label embedding feature corresponding to the frame pair by inputting the motion field into the AI network; fuse the motion embedding feature with the non-occluded-category label embedding feature to obtain a fused embedding feature; obtain a target motion field by updating the motion field based on the fused embedding feature; and estimate the scene flow corresponding to the frame pair based on the target motion field.

The processor one or more processors may be further configured to: determine a neighboring point set including pixels in the second frame that correspond to a target pixel in the first frame; determine a matching level between the target pixel and pixels included in the determined neighboring point set based on a fused embedding feature corresponding to the target pixel and fused embedding features of the pixels in the neighboring point set; and obtain the target motion field by updating the motion field based on the matching level.

The one or more processors may be further configured to: obtain a weight that adjusts the motion field based on a similarity level between pixels in the first color image; and estimate the scene flow corresponding to the frame pair based on the target motion field obtained by applying the weight to the motion field.

The one or more processors may be further configured to: obtain a first correlation between the pixels of the first color image by inputting the color first image into an attention encoder of the AI network; and determine a first weight corresponding to the first color image based on the first correlation.

The one or more processors may be further configured to: obtain a second correlation between pixels of the second color image by inputting the second color image into the attention encoder; determine a second weight corresponding to the second color image based on the second correlation; and obtain a fused weight that adjusts the motion field by fusing the first weight and the second weight.

Other features and aspects will be apparent from the following detailed description, the drawings, and the claims.

### BRIEF DESCRIPTION OF THE DRAWINGS

FIG. 1 illustrates an example of a method performed by an electronic device according to one or more example embodiments.

FIG. 2 illustrates an example of a structure of an artificial intelligence (AI) network architecture according to one or more example embodiments.

FIG. 3 illustrates an example of a network structure corresponding to a feature extraction and correlation module according to one or more example embodiments.

FIG. 4 illustrates an operational principle of a multi-head convolutional gated recurrent unit (CGRU) and a differentiable dense pose-level network layer according to one or more example embodiments.

FIG. 5 illustrates an example of a method performed by an electronic device to train an AI network according to one or more example embodiments.

FIG. 6 illustrates an example of a method performed by an electronic device to obtain training losses to train an AI network according to one or more example embodiments.

FIG. 7 illustrates an example of an electronic device according to one or more example embodiments.

Throughout the drawings and the detailed description, unless otherwise described or provided, the same or like drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

At least some functions of an electronic device according to various example embodiments may be implemented through an artificial intelligence (AI) model. For example, the AI model may be used to implement modules of the device or electronic device. In this case, such functions associated with the AI model may be performed by a non-volatile memory, a volatile memory, or a processor.

Although “the electronic device” is referred to herein, it will be appreciated that this phrase does not necessarily refer to the same device throughout. Moreover, although the singular (e.g., a pixel or feature) is often used herein, depending on context, descriptions of a thing in the singular may be representative of a plurality of those things. For example, description of a piece of information in or from an image frame or a frame pair may be representative of multiple pieces of such information.

The processor may include one or more processors. The one or more processors may be a general-purpose processor, such as, for example, a central processing unit (CPU), an application processor (AP), and the like, a graphics processing unit that includes an AI-dedicated processor, such as, for example, a graphics processing unit (GPU), a vision processing unit (VPU), a neural processing unit (NPU), and/or combinations thereof.

The one or more processors may control processing input data according to predefined operational rules or AI models stored in the non-volatile memory and the volatile memory. The one or more processors may provide the predefined operational rules or AI models through training or learning.

In this case, such a learning-based provision may involve applying a learning algorithm to multiple pieces of training data to obtain the predefined operational rules or AI models with desired characteristics. In this case, training or learning may be performed on the device or electronic device itself on which an AI model is executed, and/or may be implemented by a separate server, device, or system.

An AI model may include layers of a neural network. Each layer may have weight values, and a neural network computation may be performed by computations between a computational result from a preceding layer and/or and weight values. The neural network may include, as non-limiting examples, a convolutional neural network (CNN), a deep neural network (DNN), a recurrent neural network (RNN), a restricted Boltzmann machine (RBM), a deep belief network (DBN), a bidirectional recurrent deep neural network (BRDNN), a generative adversarial network (GAN), and a deep Q-network.

The learning algorithm may involve training a predetermined target device (e.g., a robot) using multiple pieces of training data to guide, allow, or control the target device to perform determination and estimation (or prediction). The learning algorithm may include, as non-limiting examples, supervised learning, unsupervised learning, semi-supervised learning, or reinforcement learning.

The AI model may be processed by an AI-dedicated processor. This AI-dedicated processor may have a hardware structure specific for processing AI models. The AI model may be obtained through training to reflect predefined operational rules or AI models configured to perform expected features (or purposes) are obtained by training an underlying AI model with multiple pieces of training data through a learning algorithm.

A method performed by an electronic device according to various example embodiments may be applied to any of the following technical fields: speech, language, image, video, or data intelligence. For example, in the field of speech or language, the method performed by the electronic device may include receiving a speech signal of an analog signal via an audio acquisition device (e.g., a microphone) and converting the speech into a computer-readable text using an automatic speech recognition (ASR) model. The electronic device may interpret the text and analyze the intent of a user language by using a natural language understanding (NLU) model. The ASR model or NLU model may be an AI model. Here, language understanding is a technique for recognizing and applying/processing human language/text, such as, for example, natural language processing, machine translation, dialog systems, question answering, or speech recognition/synthesis.

For example, in the field of image or video processing, the method performed by the electronic device may include obtaining output data that identifies relevant information in a pair of images or frames (or an “image pair” or “frame pair”) by using frame data as input data for an AI model. Image/video processing may include, for example, object recognition, object tracking, image retrieval, human recognition, scene recognition, three-dimensional (3D) reconstruction/positioning, or image augmentation, and these may be performed by the electronic device on images or videos.

Some embodiments may involve performing information recommendations and/or data processing by using an AI model. A processor of the electronic device may preprocess data and convert the data into a form suitable for use as an input to the AI model. An AI model may be used for inferential prediction, that is, making logical inferences and predictions based on determined information, and may include knowledge-based inference, optimized prediction, preference-based planning or recommendation, and the like.

Methods disclosed herein may be applied to the field of AI-based visual understanding. For example, methods performed by an electronic device according to example embodiments described herein may obtain a scene flow corresponding to a pair of frames (a “frame pair”) by using the frame pair as an input to an AI network/model.

Image processing techniques disclosed herein may be applied to scenarios that require scene flow estimation, for example, object detection, segmentation, and pose trajectory inference, but examples are not limited thereto. The frame pairs may be collected during autonomous driving, and information about a current autonomous driving environment may be obtained based on an estimated scene flow; an autonomous vehicle may use the scene flow estimation to perform autonomous driving more safely and reliably.

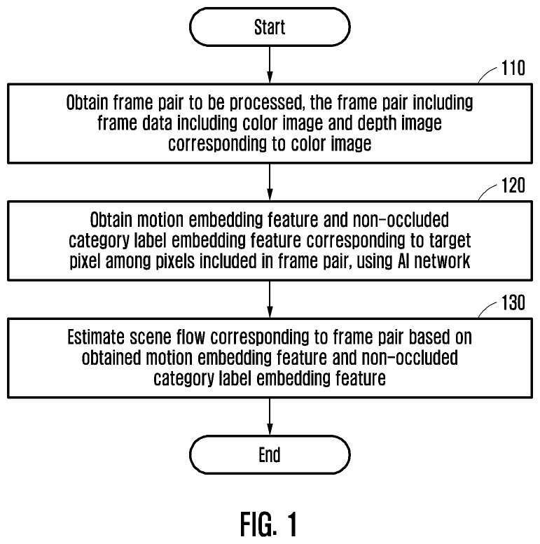

FIG. 1 illustrates an example of a method performed by an electronic device according to one or more example embodiments.

According to an example embodiment, an electronic device may estimate a scene flow corresponding to a pair of frames. For example, the electronic device may estimate a scene flow that indicates a change in an object and/or background included in the frame pair. The electronic device may perform the following operations.

At operation 110, the electronic device may obtain a frame pair. The frame pair may include two frames captured at respective time points. For example, The frames may be successive video frames, for example, from video captured or at a frame rate (e.g., X frames per second (FPS)). A frame sequence may be obtained by downsampling frames from the video based on a predetermined sampling rate (e.g., one half×FPS). The frame pair may be neighboring frames in the downsampled frame sequence. The frame pair may be referred to as having a first frame captured at a first time point and a second frame captured at a second time point after the first time point.

A frame may be/include an image with color information and depth information for each pixel thereof. For example, first frame may include a first color image and a first depth image, and the second frame may include a second color image and a second depth image. For example, the color images may conform to a red, green, blue (RGB) color space. However, a color space of a color image is not limited to the RGB color space. A frame including a color image and a depth image may also be referred to as an RGB-D (RGB-depth) image captured by an RGB-D camera, for example.

The color image and the depth image included in each frame may correspond to each other, meaning that they are captured at the same or close (e.g., within 1/60th of a second) time points.

At operation 120, the electronic device may use an AI network to obtain a motion embedding feature and an associated non-occluded-category label (a label indicating one of any variety of particular types/categories of non-occlusion) embedding feature both corresponding to a target pixel among pixels included in the frame pair. The motion embedding feature described herein may be a vector that represents a motion state of an object included in the frame pair. For example, the motion embedding feature/vector may represent a movement path, a movement direction, and/or a movement speed of the object included in the frame pair. The motion embedding feature may also be referred to as a rigid-motion embedding feature. Objects included in the frame pair may be soft-grouped into groups of different rigid objects based on their corresponding motion embedding features. For example, the electronic device may divide different rigid objects included in the frame pair into different groups based on the motion embedding feature. To elaborate, a soft group may include objects that have similar rigid-motion embedding vectors, and a single object can possess multiple vectors. For instance, one part of the object may be associated with a first motion vector, while another part may correspond to a second motion vector.

The non-occluded-category label embedding feature may represent an embedding vector indicative of a category to which an object corresponding to the target pixel belongs. For example, pixels corresponding to a specific object included in a frame may have the same or similar non-occluded-category label embedding features. Non-occluded-category label embedding features may be determined to be of a same object (or point, etc.) when they are within a threshold range with respect to each other in a vector space (e.g., a cluster), but examples of which are not limited thereto. For example, a non-occluded-category label embedding feature may characterize a category to which a pair of pixels (i.e., a “pixel pair”) in the frame pair belongs. The pixel pair described herein may include two pixels indicative of a corresponding point or object and may include, for example, a first pixel among pixels in a first frame and a second pixel among pixels in second frame, the second pixel corresponding to the first pixel. Therefore, a category to which an object corresponding to the first pixel belongs and a category to which an object corresponding to the second pixel belongs may be the same. For example, the pixels of a pixel pair may correspond to a moving object in their images or they may correspond to a non-occluded background region in their images. Therefore, the pixel pair may have geometric consistency and may include the same or at least similar pose information.

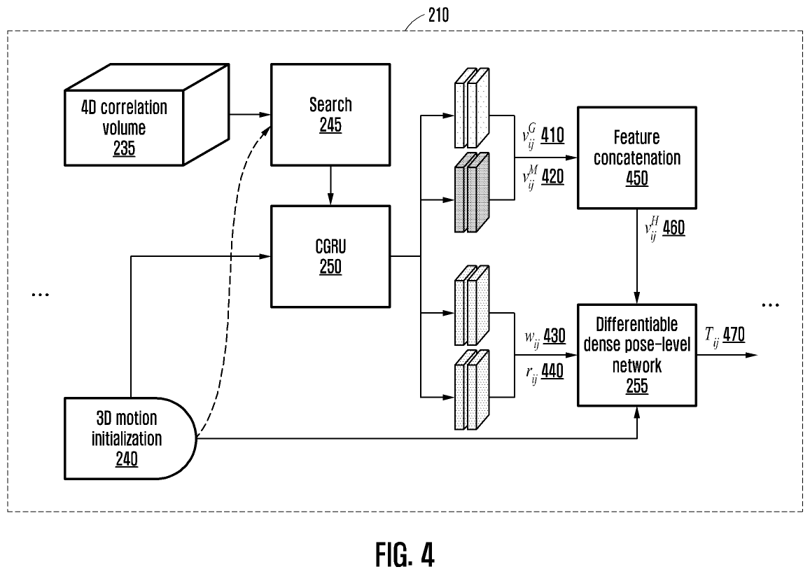

The electronic device may perform soft grouping on pixels based on motion embedding features and the non-occluded-category label embedding features. For example, the electronic device may group pixels having same/similar motion embedding features and pixels having the same/similar non-occluded-category label embedding features into a group of pixels corresponding to (or representing) a same object. For example, the electronic device may perform soft grouping on the pixels based on fused embedding features of the respective pixels (or pixel pairs). A fused embedding feature of a pixel (or pixel pair) may be formed by fusing the pixel's motion embedding feature with the pixel's non-occluded-category label embedding feature. A method of using fused embedding features is described with reference to FIG. 4.

It is to be noted that various features described herein may also be referred to as different terms or designations. For example, the non-occluded-category label embedding feature may also be referred to as a geometric segmentation feature, a segmentation feature, a first feature, a category mask feature, or a geometric segmentation mask feature.

The electronic device may more accurately classify pixels included in a frame by combining corresponding non-occluded-category label embedding features. Further, a non-occluded-category label embedding feature and a motion embedding feature both corresponding to a rigid object may be extracted based on a trained AI network. Based on combining (e.g., fusing) the extracted non-occluded-category label embedding feature and the extracted motion embedding feature corresponding to the rigid object, objects included in a frame pair may be accurately soft-grouped. That is, the electronic device may soft-group all the pixels in a frame pair into multiple groups. In this case, pixels belonging to the same soft group may have the same three-dimensional (3D) motion information (e.g., pose).

At operation 130, the electronic device may estimate a scene flow corresponding to a frame pair based on its motion embedding feature and its non-occluded-category label embedding feature. For example, the scene flow corresponding to the frame pair may be obtained by applying the AI network to the frame pair having the color information and the depth information. That is, the electronic device may obtain/infer motion information, e.g., three-dimensional (3D) motion information or two-dimensional (2D) motion information (i.e., optical flow) that occurs when an object (or portion thereof) has corresponding points (e.g., pixels) in the frame pair that change from the first frame to the second frame.

The motion information may represent motion of an object occurring between a time point of the first frame and a time point corresponding to the second frame (to be referred as first and second time points).

For example, the motion information may include information indicating motion of an object captured in vision data between two time points. For example, the motion information may indicate a movement, corresponding to an object/point, from a pixel position in a first frame at a first time point to a pixel position in second frame at a second time point. For example, the motion information may include 2D motion information (e.g., optical flow) representing 2D movement from the pixel position in the first frame at the first point in time to the pixel position in the second frame at the second point in time. The motion information may include 3D motion information representing a 3D motion that includes a movement in a depth direction/dimension in addition to the 2D motion information.

According to an example embodiment, the electronic device may identify object regions in the frame pair based on the scene flow. That is, the electronic device may identify various regions based on consistent geometry (e.g., geometric consistency) and instance consistency (e.g., identical pose information) of the frame pair. For example, based on the geometric consistency and the instance consistency of the frame pair, the electronic device may identify a background region, a rigid dynamic object region, a non-rigid dynamic object region, an occluded region, and an out-of-boundary region. For example, a pixel (of an object) in the first frame may or may not be matched to a pixel in the second frame. For example, due to motion of the object from the first frame to the second frame, a hypothetical corresponding pixel of the object may be absent or occluded in the second frame. Accordingly, the electronic device may determine which of the non-occluded-categories that pixels in the frame pair belong to based on the motion embedding features and the non-occluded-category label embedding features thereof. For example, the electronic device may identify, in the frame pair, pixels corresponding various in-motion objects and pixels in a non-occluded background region (or a static region, which may also be referred to as a non-motion region).

The electronic device may soft-group the pixels in the frame pair into regions (e.g., a first region, a second region, and a third region, none of which are necessarily self-contiguous), based on the motion embedding features and the non-occluded category label embedding features. For example, the first region may be a non-occluded and non-out-of-boundary region with geometric self-consistency. For example, the second region may be non-occluded and non-out-of-boundary dynamic object regions with geometric self-consistency. For example, the third region may be other geometrically consistent regions. In this case, geometric consistency of a region refers to pixels included in the region having a substantially same motion field and/or pose (e.g., with similarities to each other that are within a threshold).

The motion field may be a field of vectors indicative of how respective pixels move between two successive images. For example, the motion field may include a vector indicating whether a specific pixel corresponding to an object in the first frame has moved to a position of a corresponding pixel in the second frame data. The motion field may include a vector field with vectors corresponding to an object or a motion of the object for each of the pixels, respectively. Based on more accurate soft grouping of the pixels, the electronic device may obtain an accurate scene flow estimation result.

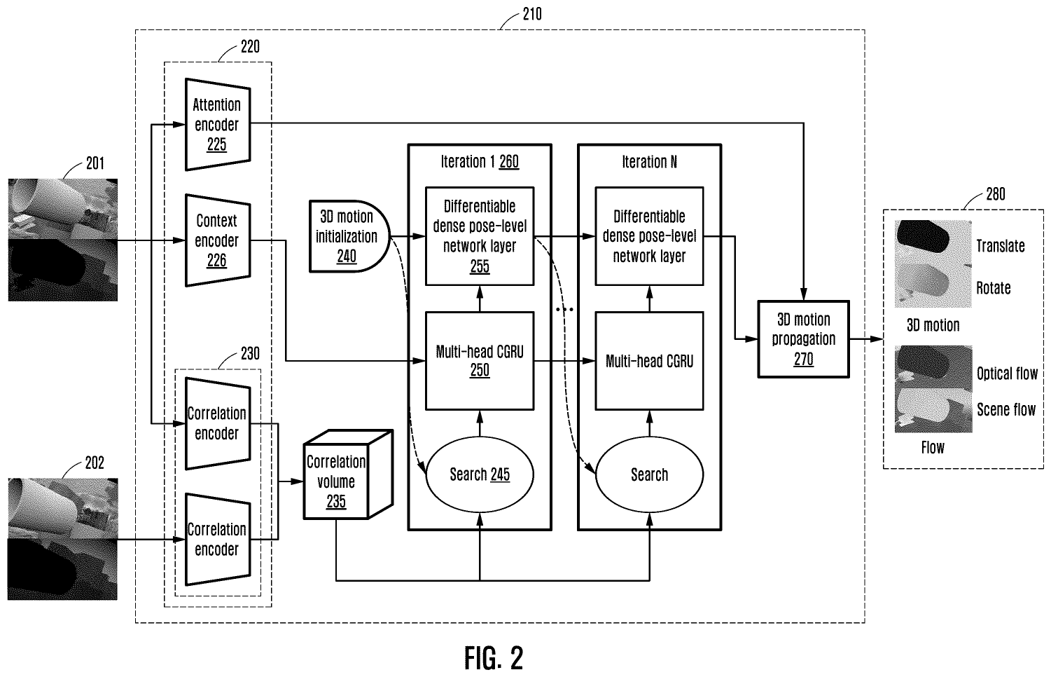

The network structure of the AI network for performing the methods described herein may include, as non-limiting examples, a neural network model built based on a recurrent all-pairs field transforms (RAFT)-3D (RAFT-3D) (a type of deep neural network) that may be configured for estimating optical flows. In other words, the electronic device may optimize and improve the RAFT-3D network. An example of the AI network used by the electronic device according to an example embodiment is described with reference to FIGS. 2 through 4.

According to an example embodiment, the electronic device may obtain a fused embedding feature by fusing a motion embedding feature and a corresponding non-occluded-category label embedding feature. A target motion field may be obtained by updating the motion field based on fused embedding features to minimize a reprojection error between pixels of pixel pairs in a frame pair. The electronic device may obtain the scene flow corresponding to the frame pair, based on the target motion field.

In some embodiments, the electronic device may initialize a first motion field (e.g., an initial motion field and/or initial pose) corresponding to the frame pair. For example, the initialized first motion field may be a 3D motion field corresponding to the frame pair. For example, the first motion field may be initialized in the process of a scene flow initialization method of the RAFT-3D network, e.g., a special Euclidean group (SE(3)) motion initialization method or a dense pose-level motion or pose initialization method.

In some embodiments, the electronic device may obtain the target motion field by performing a motion field update operation on the initial motion field. For example, the electronic device may obtain an updated motion field (e.g., a second motion field) by performing the motion field update operation on the initial motion field (e.g., the first motion field). The electronic device may obtain a third motion field by updating again the updated motion field (e.g., the second motion field). The electronic device may again perform the update operation on the currently updated motion field. That is, the electronic device may refine the motion field by iteratively updating the motion field in the form of a feedback loop. The electronic device may obtain the target motion field by iterating the motion field update operation a predetermined number of times (e.g., N greater than 1). The motion field may be improved by iterating the motion field update operation. As the motion field is improved, the scene flow is more accurately estimated.

According to an example embodiment, the electronic device may obtain motion embedding features and non-occluded-category label embedding features corresponding to the frame pair based on a current motion field (e.g., a motion field that is a target to be updated). The electronic device may fuse the obtained motion embedding features and the obtained corresponding non-occluded-category label embedding features to obtain fused embedding features. The motion field may be updated based on the fused embedding features and may then obtain the updated motion field on which a subsequent update operation is to be performed, which may minimize the reprojection error between the pixels of pixel pairs in the frame pair. For example, the target motion field may be obtained through the update operation iteratively performed a predetermined number of times on the motion field. The electronic device may update the motion field such that a difference in information representing a pose and/or motion of the same object or a point (or position) of the object in the frame pair is decreased or minimized. A method performed by the electronic device to update the motion field is described with reference to FIG. 4.

The target motion field may include a rotation component and/or a translation component corresponding to a rotation and/or translation of an object in the frame data. The electronic device may obtain a scene flow by projecting the target motion field onto one of the frames.

As noted, fused embedding features may be obtained by fusing the motion embedding features with their corresponding non-occluded-category label embedding features. A method of fusing the embedding features is not limited to a particular one. Based on the fused embedding features, the electronic device may soft-group pixels into geometrically consistent regions (e.g., pixels corresponding to the same or similar object) in the frame pair. For reference, fused embedding features of point pairs (e.g., a pixel point pair or pixel pair) with geometric consistency may be similar to each other. Therefore, the electronic device may obtain the target motion field by updating (e.g., optimizing or initializing) the motion field based on a matching level (e.g., a distance or a similarity level) between fused embedding features of pixel point pairs. The matching level between any two fused embedding features (of two respective pixel pairs) may be calculated based on a distance between the fused embedding features; the matching level may be calculates as an L2 distance, for example.

As noted, the electronic device may update the motion field based on the fused embedding feature. For example, for the pixels in the first frame data, the electronic device may determine respectively corresponding sets of neighboring points (or simply a “neighboring point set” herein) in the second frame data. Specifically, for a given first pixel (representative of all first pixels) in the first frame, there is a matching second pixel in the second frame. The first pixels and second pixels may be matched one to one. A neighboring point set of a first pixel may be set to include pixels in a region adjacent to the second pixel that is matched to the first pixel, as a non-limiting example. For example, the neighboring point set of a first point may be those pixels disposed within a predetermined pixel distance from its matching second pixel. The electronic device may determine, based on a fused embedding feature corresponding to a pixel (e.g., a first pixel) and fused embedding features corresponding to pixels included in the neighboring point set of the pixel, a matching level between the pixel and each of the pixels included in the neighboring point set. The electronic device may extract the fused embedding feature corresponding to the pixel and the fused embedding features of the respective pixels in its neighboring point set. Distances (e.g., the L2 distance) between (i) the fused embedding feature corresponding to the pixel and (ii) the fused embedding features of the pixels included in the neighboring point set may be respectively calculated; the distance may be shorter as motion of an object corresponding to the pixel and motion of an object corresponding to the pixels included in the neighboring point set are more similar to each other.

According to an example embodiment, the electronic device may update the motion field based on the matching levels between the first pixel and the respective pixels in its neighboring point set. By updating the motion field as described above, the reprojection error between the pixel (e.g., the first pixel) included in the first frame and the pixels in its neighboring point set in the second frame may be reduced or minimized. The electronic device may then obtain the target motion field based on the updated motion field.

According to some embodiments, the electronic device may extract image features from the frame pair to obtain a feature map with a reduced resolution (relative to the frames). The feature map may be up-sampled to obtain an image of the same size as an input image/frame. For reference, as used herein, depending on context, “pixel” refers to either a pixel point that constitutes an image or a feature point in a feature map depending on the context. Of feature points included in the feature map, one feature point may correspond to one pixel included in one of the frames (e.g., the first frame).

The pixels in the first frame of the frame pair may respectively (i.e., one to one) correspond to the pixels in the second frame of the frame pair. In addition, feature points in a first feature map corresponding to the first frame may respectively correspond to feature points in a second feature map corresponding to the second frame of the frame pair. For example, the electronic device may calculate pixels (e.g., the second pixels in the second frame (respectively corresponding to the first pixels in the first frame), based on a projection and/or back-projection operation on a spatial point in a camera coordinate system. For example, the electronic device may project a target point of an object in the first frame data into a 3D space to determine a movement point to which the target point has moved in the second frame data. The electronic device may calculate a pixel (e.g., the first pixel) corresponding to the target point of the object in the first frame. The electronic device may calculate the second pixels corresponding to the movement point in the second frame data. The first pixels and the second pixels may correspond to the target points of the same object. Similarly, the electronic device may calculate the second pixels corresponding to the first pixels based on the back-projection operation that converts points corresponding to the object in 2D frame data into the 3D space.

For reference, a neighboring point set may include the second pixel in the second frame (e.g., the center of the neighborhood) and pixels located within a predetermined pixel distance from the second pixel. A pixel (e.g., the first pixel) in the first frame and pixels within a neighboring region range (e.g., the neighboring point set) in the second frame corresponding to the pixel may indicate the same or similar pose of the object. A greater difference in pose between an object point corresponding to the first pixel and object points corresponding to its neighboring point set may indicate an inaccurate current motion field. For each pixel, the electronic device may extract a fused embedding feature between a pixel and each of pixels within the neighboring region range corresponding to the pixel. The electronic device may calculate matching levels between the extracted fused embedding features. The electronic device may update the motion field of the frame pair based on the calculated matching levels. The electronic device may optimize the motion field by updating the current motion field. That is, the motion field may be updated such that pixels corresponding to the same or similar object have the same or similar 3D motion information and/or pose. The electronic device may thereby minimize the reprojection error in the pixel pair.

In some embodiments, the electronic device may calculate reprojection errors between the first pixel in the first frame and the pixels of its neighboring point set in the second frame. Matching levels between the first pixel and the pixels of its neighboring point set may be calculated. Based on the calculated reprojection errors and the calculated matching levels, the electronic device may calculate a cost according to a predetermined cost function. Pose information corresponding to each of the pixels in the first frame may be updated to reduce or minimize the cost. In this case, a value of the cost function may be determined by a weighted reprojection error between the first pixel and each of the pixels its neighboring point set. The weights of the reprojection errors respectively corresponding the pixels in the neighboring point set may be determined based on their respective matching levels with respect to the first pixel (weights may be computed on a per-pixel basis). While the electronic device iterates the motion field update operation, it may set an initial value of the reprojection error to be the reprojection error in a pixel pair obtained from the current motion field (e.g., the updated motion field) on which the motion field update operation is based.

The electronic device may obtain weights for adjusting the motion field based on similarity levels between pixels in at least one color image of the frame pair. For example, the electronic device may obtain the weights that adjusts the motion field based on similarity levels between pixels of a color image (e.g., a first color image) in the first frame. The electronic device may apply the weights to the motion field to obtain an updated motion field. For example, the electronic device may apply the weights to the current motion field to update the current motion field. The electronic device may calculate weights each time the motion field update operation is performed and apply the weights to the motion field to finally obtain the target motion field. Based on the target motion field, the electronic device may estimate the scene flow corresponding to the frame pair.

For reference, a frame in a frame pair may include pixel corresponding to occluded region(s) and/or pixels corresponding to out-of-boundary region (e.g., of pixels corresponding to points of an object in the first frame but not in the second frame). It may be relatively difficult for the electronic device to perform motion estimation on pixels corresponding to occluded region(s) and/or pixels corresponding to the out-of-boundary region, and therefore a scene flow estimate may have a large error. Therefore, the electronic device may continuously and iteratively update the motion field. According to an example embodiment, the electronic device may obtain the target motion field of the frame pair by updating the motion field a predetermined number of times. A scene flow and an image itself may have a high level of structural similarity. Accordingly, the electronic device may (i) propagate estimated scene flow values for pixels corresponding to non-occluded regions to estimated scene flow values for pixels corresponding to occluded regions and may (ii) propagate estimated scene flow values for pixels corresponding to an in-boundary region to estimated scene flow values for pixels corresponding to an out-of-boundary region. The electronic device may estimate a scene flow by measuring self-similarities of features. For example, the electronic device may obtain the weights that adjust the target motion field based on a self-correlation between pixels in the frame. The motion field may be updated by applying the weights to the motion field. A more accurate scene flow may be obtained based on the updated motion field.

According to some embodiments, the AI network may include an attention encoder. Using the AI network including the attention encoder, the electronic device may obtain correlations between pixels of at least one color image in the frame pair. The weights that adjust the motion field may be determined based on the correlations. For example, the electronic device may determine a first weight based on a correlation between pixels of a first color image. The electronic device may determine a second weight based on a correlation between pixels of a second color image. The electronic device may fuse the first weight and the second weight to obtain a fused weight that adjusts the motion field. The electronic device may fuse the first weight and the second weight by calculating an average value of the first weight and the second weight, as a non-limiting example. The first color image and the second color image may be two different color images in the frame pair.

The attention encoder may be based on a self-attention mechanism. For example, the electronic device may input one color image (e.g., the first color image or the second color image) of the frame pair to the attention encoder. The electronic device may learn an image feature of the color image through the attention encoder. The electronic device may learn a correlation between pixels of the color image based on the learned image feature to obtain a weight that adjusts the motion field. That is, the electronic device may obtain a self-attention weight corresponding to one of the color images by the attention encoder. The electronic device may input each of two color images of the frame pair into the attention encoder to obtain weights respectively corresponding to the color images. The electronic device may then fuse (e.g., average) the two weights to adjust the target motion field using the fused weight.

According to an example embodiment, the electronic device may obtain a motion field in the form of a feature map. The electronic device may obtain weights that are to be used to adjust the motion field in the form of a weight map. The size of the feature map of the motion field may be the same as the size of the weight map. The motion field may be adjusted by applying the weight map to the feature map of the motion field. Specifically, weight values of position points in the weight map may be applied to pose information of respectively corresponding positions in the motion field. For example, the motion field may be adjusted by multiplying (e.g., a Hadamard product) a feature point in the motion field (in the form of the feature map) by a feature point in the weight map of the same size. That is, in a case where a motion field is a feature map of the size of M×N, the electronic device may adjust the motion field by multiplying each component of the motion field by a weight map of the size of M×N.

According to some embodiments, the electronic device may obtain the motion embedding features and the non-occluded-category label embedding features of the frame pair, based on the motion field corresponding to the frame pair, using the AI network. First frame features of the first frame and second frame features of the second frame may be extracted using a feature encoder in the AI network. The electronic device may generate a correlation volume corresponding to the frame pair, based on correlations between the first frame features and the second frame features. For reference, the correlation volume may include a 3D matrix or tensor that represents a correlations between two frames (e.g., successive images). The electronic device may generate the correlation volume by calculating similarity levels (according to the extracted features) between corresponding pixels in the two frames. For example, the electronic device may extract context features and initial hidden states corresponding to the first frame using a context encoder in the AI network. Using the AI network, the electronic device may obtain the motion embedding features and the non-occluded-category label embedding features corresponding to the frame pair, based on the context features, the initial hidden states, the motion field corresponding to the frame pair, and the correlation volume.

As described above, the electronic device may obtain the target motion field corresponding to the frame pair by updating the initialized motion field until a predetermined number of times is reached or a predetermined condition (e.g., a predetermined convergence condition for the motion field) is satisfied. Here, the motion field to be updated first by the electronic device may be an initial motion field (e.g., a first motion field). The electronic device may then update the previously-updated motion field at a subsequent iteration of the update operation on the motion field.

According to an example embodiment, the electronic device may obtain the motion embedding features and the non-occluded-category label embedding features from the motion field that is a target to be updated. The electronic device may iteratively perform the update operation on the motion field based on the correlation (e.g., the correlation volume) between the pixels of the pixel pairs in the frame pair, the contextual features of the first frame, the initial hidden states obtained by performing feature extraction on the first frame, and the initialized first motion field. For example, such an iterative update operation performed by the electronic device on the motion field may include updating the motion field in the RAFT-3D network. However, the electronic device may output the non-occluded-category label embedding features, in addition to the motion embedding features, from the AI network, as opposed to the RAFT-3D network. Further, the electronic device may also use the fused embedding features in which the motion embedding features and the non-occluded-category label embedding features are fused to update the motion field, rather than performing the update on the motion field based solely on the motion embedding feature. The AI network may include a convolutional gated recurrent unit (CGRU) as described below.

According to an example embodiment, the electronic device may obtain frame features from a color image and a depth image (e.g., of the first frame or the second frame). For example, the electronic device may obtain frame features respectively corresponding to images of a frame pair based on color images and depth images in respective frames. In this case, by fusing color information and depth information, the electronic device may extract the frame features that are more representative of features of the images. Therefore, the extracted frame features may have more image-related information compared to frame features extracted simply from the color images. After obtaining the frame features from the respective images, the electronic device may calculate a correlation between the frame features of two frames to obtain a four-dimensional (4D) correlation volume of the two frames. For example, the electronic device may use, in the RAFT-3D network, a method of calculating a correlation volume corresponding to two frames. For example, the electronic device may obtain the correlation volume by obtaining a scalar products between first frame features and second frame features. The electronic device may calculate the correlation volume between the two different frames based on frame features in which image information from color images and depth images in the two different frame is fused, rather than using only features extracted from the two different color images alone.

The context features and the initial hidden states may be obtained by fusing the first color image and the first depth image. That is, the electronic device may obtain the context features and the initial hidden states from image semantics and contextual information that are extracted by inputting the first color image and the first depth image into the context encoder.

In some embodiments, after initializing the first motion field, the electronic device may calculate an initial flow field, a twist field, and a depth residual corresponding to the frame pair based on the first motion field. The electronic device may also locate corresponding correlation features (e.g., correlation features between a pixel and each of pixels in a neighboring point set corresponding to the pixel) from the correlation volume, based on 2D pixel coordinates obtained based on a change in the initial flow field. The electronic device may use, as input information for the AI network (e.g., a gated recurrent unit (GRU)), the context features, the initial hidden features, the initial flow field, the twist field, the depth residual, and the correlation features. The electronic device may thereby generate a new hidden state through the AI network. Based on the new hidden state, the electronic device may obtain a correction item corresponding to the scene flow (e.g., a correction item of a flow field), motion embedding features, non-occluded-category label embedding features, and confidence features. The electronic device may obtain a new motion field by iteratively updating the motion field, based on the obtained correction item, motion embedding features, non-occluded-category label embedding features, and confidence features.

For reference, confidence features may be in the form of a confidence feature map (or simply a “confidence map”) that is used to update the motion field. For example, a feature value of the confidence feature may represent a confidence associated with a matching level/degree between pixels in a pixel pair. For example, a lower confidence may indicate a lower matching level of the pixel pair and a lower probability that the pixels of the pixel pair are in the same group. The electronic device may also limit the reprojection error between the pixels in the pixel pair and correct the reprojection error, based on the confidence.

The correction item corresponding to the scene flow may include a correction item of a flow field. The flow field may also be referred to as an optical flow. The electronic device may update the flow field used for the motion field at the time of updating the current motion field, using the corresponding correction item. For example, the electronic device may update the current motion field, using the corresponding correction item. In this case, the electronic device may correct the reprojection error corresponding to the pixel pair calculated based on the current motion field and may obtain a new flow field based on the updated motion field.

In some embodiments, the electronic device may obtain the updated motion field based on the correction item corresponding to the scene flow, the confidence feature, and the fused embedding feature, and may then calculate a new flow field, a new twist field, and a new depth residual based on the updated motion field. The electronic device may obtain a correlation feature from the correlation volume. The electronic device may obtain updated input information (e.g., the motion field) including a combination of the context feature, the new hidden state generated in a preceding iterative update, the new flow field, the new twist field, the new depth residual, and/or the re-searched correlation feature. The electronic device may input the obtained input information into the AI network to obtain a newly updated motion field.

The electronic device may continue to repeat the iterative update process until a predetermined number of times (or condition) is reached to obtain the target motion field.

In some embodiments, the electronic device may fuse the motion embedding features and the non-occluded-category label embedding features to obtain the fused embedding features during the iterative update process performed on the motion field. The electronic device may update the motion field based on the fused embedding features and the confidence features. In other words, to update the motion field, the electronic device may fuse the motion embedding features and the non-occluded-category label embedding features and more accurately soft-group pixels in the images. Accordingly, the electronic device may improve the accuracy of the estimated scene flow.

According to an example embodiment, the electronic device may use an end-to-end AI network for scene flow estimation. The electronic device may use the AI network to combine (or concatenate) a geometric feature and a segmentation feature of an image to extract a non-occluded-category label embedding feature. The electronic device may thus optimize scene flow estimation through the AI network, based on the non-occluded-category label embedding features. For example, the electronic device may use an attention mechanism that propagates the scene flow estimation from non-occluded regions and an in-boundary region to occluded region and an out-of-boundary region, respectively, to optimize an overall scene flow between two frames. For example, the electronic device may use an attention mechanism that assigns weights to a motion field based on a self-correlation of the image and updates the motion field accordingly.

A specific network architecture of the AI network according to an example embodiment may be modified. An example structure of the AI network is described below with reference to FIG. 2. For example, the AI network may include an enhanced RAFT-3D network, and the enhanced RAFT-3D network may be referred to as a RAFT-3D++ network or a RAFT-3D++ system.

FIG. 2 illustrates an example of a structure of an AI network architecture according to one or more example embodiments.

The AI network 210 illustrated in FIG. 2 may be an end-to-end scene flow estimation network that combines (or concatenates) a geometric feature and a segmentation feature, which are in a frame pair, to optimize scene flow estimation. As shown in FIG. 2, the AI network 210 may include a feature extraction and correlation module 220, a multi-head CGRU module 250, a differentiable dense pose-level network layer 255, and an attention mechanism (e.g., a 3D motion propagation module 270 of FIG. 2).

For example, the electronic device may input a frame pair (e.g., a first frame 201 and a second frame 202) into the AI network 210. For reference, the first frame 201 may include a color image and a depth image, and the second frame 202 may also include a color image and a depth image. The first frame 201 and the second frame 202 may represent successive images. For example, the first frame 201 may represent an image captured at a relatively preceding time than the second frame 202. For example, the first frame 201 may be an image captured at a first time point, and the second frame 202 may be an image captured at a later second time point.

The electronic device may input the first frame 201 and the second frame 202 into the feature extraction and correlation module 220 in the AI network 210. In this case, the electronic device may input the first frame 201 into an attention encoder 225, a context encoder 226, and a correlation encoder 230 in the feature extraction and correlation module 220, and may input the second frame 202 into the correlation encoder 230.

The electronic device may extract a self-correlation between pixels in the color image in the first frame 201, using the attention encoder 225. The electronic device may propagate the extracted self-correlation to the 3D motion propagation module 270. The attention encoder 225 and the 3D motion propagation module 270 will also be collectively referred to as the attention mechanism.

The electronic device may extract hidden states and context features corresponding to objects in the first frame 201 from the first frame 201, using the context encoder 226. The electronic device may transfer the extracted hidden states and context features to the multi-head CGRU 250.

The electronic device may obtain a correlation volume 235 that is based on a correlation between the first frame 201 and the second frame 202, using the correlation encoder 230. The correlation volume is 235 described above with reference to FIG. 1.

The electronic device may initialize the attention feature extracted by the attention encoder 225, the hidden states and context features extracted by the context encoder 226, and a motion field corresponding to the first frame 201 and the second frame 202, using a 3D motion initialization module 240. The electronic device may transfer initialized data obtained by the initialization to a search module 245.

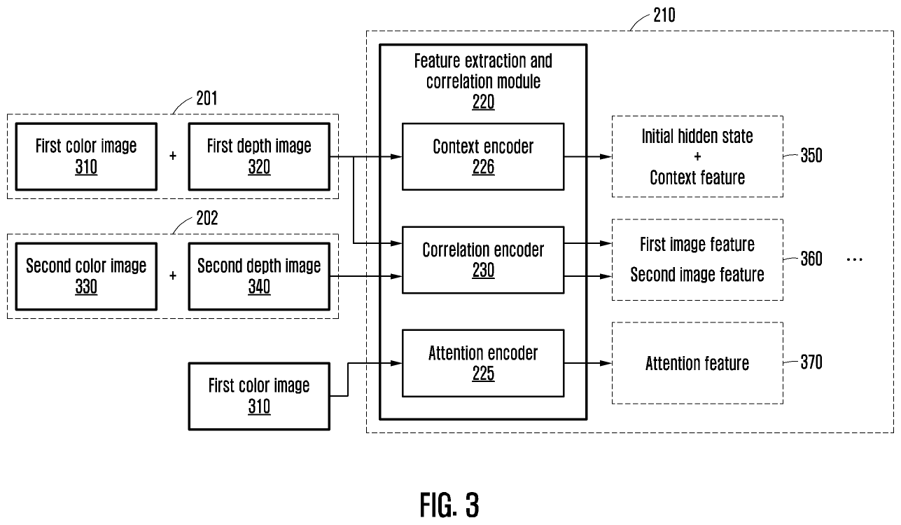

The electronic device may index a correlation feature set in the correlation volume 235 based on the data transferred from the 3D motion initialization module 240 and the correlation volume 235 received from the correlation encoder 230, using the search module 245. The indexing of the correlation feature set in the correlation volume 235 using the search module 245 is described with reference to FIG. 3.

The electronic device may transfer, to the multi-head CGRU 250, the data including the correlation feature set indexed by the search module 245 and the hidden states and context features extracted from the context encoder 226. Based on such input data, the multi-head CGRU 250 may update a hidden state corresponding to the frame pair. The multi-head CGRU 250 may also generate a motion embedding feature and a non-occluded-category label embedding feature of a pixel corresponding to an object in the first frame 201 and the second frame 202. Further, the multi-head CGRU 250 may generate a correction item and a confidence feature and update the motion field. The operations of the multi-head CGRU 250 are described with reference to FIG. 4.

The electronic device may input the data initialized by the 3D motion initialization module 240 and the data generated by the multi-head CGRU 250 into the differentiable dense pose-level network layer 255. Based on the differentiable dense pose-level network layer 255, the electronic device may generate an estimated value of a pose of the object in an image to be obtained subsequently (e.g., an image to be captured after the second frame 202) through a dense structure, while maintaining the differentiability of a change in the pose of the object in the first frame 201 and/or the second frame 202. The differentiable dense pose-level network layer 255 (or a dense-spatial Euclidean 3 layer or a dense-SE3 layer) in the AI network 210 may be used to update a spatial Euclidean (SE) 3 motion T. The electronic device may update and optimize the SE3 motion T through a Gauss-Newton iteration method using the differentiable dense pose-level network layer 255. The electronic device may use the updated and optimized SE3 motion T to classify pixels in the image (e.g., the first frame 201 and the second frame 202) into different object groups. In this case, pixels in the same object group may share the same (or highly close) SE3 motion T. That is, the electronic device may update the SE3 motion T using the differentiable dense pose-level network layer 255. The operation performed by the electronic device to estimate a motion of an object in an image based on the differentiable dense pose-level network layer 255 is described with reference to FIG. 4.

The electronic device may perform an iterative operation 260 for scene flow estimation, based on the search module 245, the multi-head CGRU 250, and the differentiable dense pose-level network layer 255. At each iterative operation 260, the electronic device may initialize (or update) the motion field corresponding to the first frame 201 and the second frame 202. The operation performed by the electronic device to perform the iterative operation 260 for estimating a scene flow is described with reference to FIG. 4.

After performing the iterative operation 260 a predetermined number of times, the electronic device may transfer an output value of the differentiable dense pose-level network layer 255 to the 3D motion propagation module 270. Using the 3D motion propagation module 270, the electronic device may generate a scene flow estimation result 280, based on the weights that are based on the correlations between the pixels in the first frame 201 (as obtained from the attention encoder 225) and the output value of the differentiable dense pose-level network layer 255. For example, the scene flow estimation result 280 may include an estimation result, which is a result of estimating a 3D motion (e.g., a translational motion or rotational motion) of the object(s) in the first frame 201 and/or the second frame 202. The scene flow estimation result 280 may also include an optical flow and a scene flow.

FIG. 3 illustrates an example of a network structure corresponding to a feature extraction and correlation module according to one or more example embodiments.

According to some embodiments, the feature extraction and correlation module 220 may include a correlation encoder 230, a context encoder 226, and an attention encoder 225. Using the correlation encoder 230, the context encoder 226, and the attention encoder 225, the feature extraction and correlation module 220 may extract features (e.g., a first feature 350, a second feature 360, and a third feature 370) from images (e.g., first frame 201 and second frame 202) in a frame pair. For example, using three coding branches, the feature extraction and correlation module 220 may extract three features including the first feature 350 (e.g., a context feature including an initial hidden state and a context feature), the second feature 360 (e.g., a correlation feature including a first frame feature and a second frame feature), and the third feature 370 (e.g., an attention feature). The first frame 201 may include a first color image 310 and a first depth image 320 corresponding to the first color image 310. The second frame 202 may include a second color image 330 and a second depth image 340 corresponding to the second color image 330.

The electronic device may use the correlation encoder 230 to extract the second feature 360 from the first frame 201 and the second frame 202. For example, using the correlation encoder 230, the electronic device may extract a dense image feature according to a predetermined resolution. For example, using the correlation encoder 230, the electronic device may extract a 128-dimensional feature vector at ⅛ resolution to build a 4D correlation volume (e.g., the correlation volume 235 of FIG. 2). That is, the electronic device may extract image features (e.g., the first frame feature and the second frame feature) from two frames (e.g., the first frame 201 and the second frame 202) of the frame pair and build the 4D correlation volume (e.g., the correlation volume 235 of FIG. 2) based on the extracted image features. However, a network structure of the correlation encoder 230 is not limited to a specific one. For example, the correlation encoder 230 may include six residual blocks, among which two residual blocks may output a feature map with ½ resolution, other two residual blocks may output a feature map with ¼ resolution, and other two residual blocks may output a feature map with ⅛ resolution.

The electronic device may use the context encoder 226 to extract the first feature 350 from the image (e.g., the first frame 201). For example, using the context encoder 226, the electronic device may extract semantics and contextual information. A network structure of the context encoder 226 is not limited to a specific one. For example, the context encoder 226 may extract a context feature at ⅛ resolution, using a pre-trained ResNet50 that includes a skip connection (e.g., a 50-layer residual neural network). The feature maps extracted by the context encoder 226 and the correlation encoder 230 may have the same resolution.

For example, the correlation encoder 230 and the context encoder 226 in the AI network 210 may correspond to a feature encoder and a context encoder of RAFT-3D, respectively.

According to some embodiments, a network corresponding to the feature extraction and correlation module 220 in the AI network 210 may include the attention encoder 225, in addition to the correlation encoder 230 and the context encoder 226. As shown in FIG. 3, the electronic device may extract the third feature 370 (e.g., the attention feature) by inputting the first color image 310 of the first frame 201 (e.g., a preceding image of the frame pair) to the attention encoder 225. For example, the electronic device may use the attention feature for subsequent propagation of 3D motion. That is, the electronic device may assign the attention feature to the motion field as a weight to update the motion field. The electronic device may input a color image (e.g., the first color image 310) to the attention encoder 225 to extract an image feature (e.g., the attention feature) of the color image. A network structure of the attention encoder 225 is not limited to a specific one. For example, a resolution of a feature (e.g., the third feature 370 such as the attention feature) extracted by the attention encoder 225 may be the same as a resolution of a feature (e.g., the first feature 350 and the second feature 360) extracted by the context encoder 226 and the correlation encoder 230. For example, the attention encoder 225 may use the same network structure as the correlation encoder 230 but may not share a network weight.

For reference, the 4D correlation volume (e.g., the correlation volume 235 of FIG. 2) may be built by calculating scalar products between feature vectors of a feature vector pair generated by the correlation encoder 230.

The electronic device may obtain a projection function and a back-projection function corresponding to a pixel (e.g., x=(u, v)) in the first frame 201 based on the motion field (e.g., when obtaining a 3D motion from images). Based on the projection function and the back-projection function corresponding to the pixel in the first frame 201, the electronic device may obtain a pixel (e.g., x′=π(Tπ⁻¹(x)) in the second frame 202 corresponding to the pixel in the first frame 201. In this case, π(·) and π⁻¹(·) denote the projection function and the back-projection function, respectively, and x=(u,v) represents 2D pixel coordinates corresponding to the pixel in the first frame 201. Here, T denotes a spatial Euclidean group (SE3) motion (e.g., the motion field or motion field/pose corresponding to the frame pair). For example, T represents motion information/pose in the second frame 202 corresponding to each pixel (e.g., x) in the first frame 201. In addition, x′, which is the pixel in the second frame 202 obtained by a coordinate transformation performed by the electronic device based on the SE3 motion, may be estimated pixel coordinates corresponding to the pixel “x” in the first frame 201. For each pixel x, the electronic device may index a correlation feature set in a correlation volume (e.g., the correlation volume 235 of FIG. 2) based on currently estimated pixel coordinates x′, using a search module (e.g., the search module 245 of FIG. 2). For reference, indexing a correlation feature set in a correlation volume may refer to a process of generating an index to efficiently locate a specific position or coordinates in the correlation volume. For example, for a correlation volume of a massive size, directly accessing all the data in the correlation volume may require an excessive amount of computation. Accordingly, the electronic device may rapidly access frequently referenced data in the correlation volume based on indexing the correlation feature set in the correlation volume.

The electronic device may use the 3D motion initialization module 240 shown in FIG. 2 to initialize the hidden state, the context feature, the attention feature, and the SE3 motion (e.g., T∈SE(3)^{H×W}) (e.g., the first motion field/initial motion field). For example, the electronic device may extract the first feature 350 including the initial hidden state and the context feature, using the context encoder 226. The electronic device may extract the third feature 370 (e.g., the attention feature), using the attention encoder 225. The electronic device may initialize the SE3 motion T by a matrix including unit rotation and zero translation.

FIG. 4 illustrates an operational principle of the multi-head CGRU 250 and the differentiable dense pose-level network layer 255 according to one or more example embodiments.

The multi-head CGRU 250 may correspond to an update network. The multi-head CGRU 250 may be a CGRU, a convolutional gated recurrent unit, which is used to iterate operations recurrently.

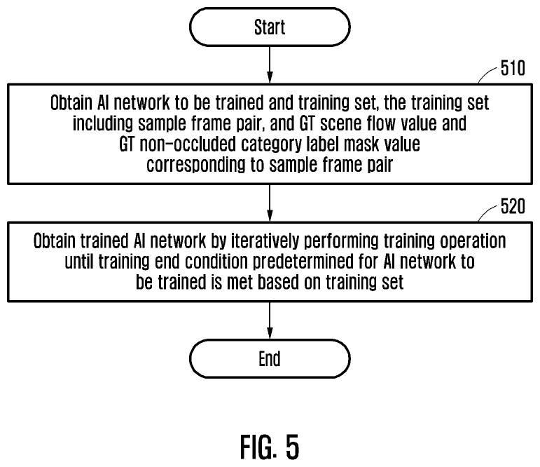

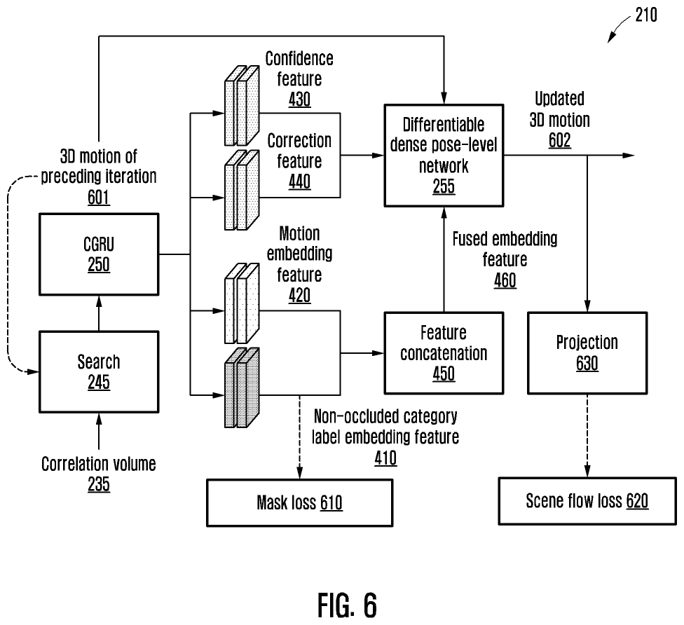

According to some embodiments, the electronic device may input a flow field, a twist field, a depth residual, a correlation feature, a context feature, and a hidden state to the multi-head CGRU 250. Using an updated hidden state, the electronic device may generate a scene flow correction feature 440 (e.g., r), a confidence feature 430 (e.g., w), a motion embedding feature 420 (e.g., v^{M}), and a non-occluded-category label embedding feature 410 (e.g., v^{G}). Although the electronic device may generate the non-occluded-category label embedding feature 410 (e.g., v^{G}) based on supervised learning of the AI network 210, a method by which the electronic device trains the AI network 210 is not limited to supervised learning. The method by which the electronic device trains the AI network 210 is described in detail below with reference to FIGS. 5 and 6. In addition, a feature in which the motion embedding feature 420 (e.g., v^{M}) and the non-occluded-category label embedding feature 410 (e.g., v^{G}) are fused may be referred to herein as a fused embedding feature 460 (e.g., v^{H}), but is not limited thereto. For example, the fused embedding feature 460 (e.g., v^{H}) may also be referred to as a soft grouping feature.

According to some embodiments, the electronic device may improve a matching quality of a pixel pair by learning the fused embedding feature 460 (e.g., v^{H}). Accordingly, the electronic device may ensure 3D geometric consistency of an object point corresponding to a pixel at different time points and instance consistency in a neighboring region including pixels within a predetermined pixel distance relative to the object point corresponding to the pixel. To learn the fused embedding feature 460 (e.g., v^{H}), the electronic device may calculate a ground truth (GT) non-occluded-category label mask value. The electronic device may use this GT value to segment an image into a static non-occluded region and a multi-dynamic non-occluded region. For example, the electronic device may segment the image into a non-occluded background region and an instance object region that moves to a non-occluded state.

That is, as shown in FIG. 4, output features of the multi-head CGRU 250 in the AI network 210 may include the motion embedding feature 420 (e.g., v^{M}), the non-occluded-category label embedding feature 410 (e.g., v^{G}), the confidence feature 430 (e.g., w), and the correction feature 440 (e.g., r). The electronic device may obtain the fused embedding feature 460 (e.g., v^{H}) in which the motion embedding feature 420 (e.g., v^{M}) and the non-occluded-category label embedding feature 410 (e.g., v^{G}) are fused. The electronic device may use the fused embedding feature 460 (e.g., v^{H}) as one of the inputs to a layer (e.g., the differentiable dense pose-level network layer 255) for updating the motion field.

According to some embodiments, at an iterative operation (e.g., the iterative operation 260 of FIG. 2), the electronic device may input the flow field, the twist field, the depth residual, and the 4D correlation volume (e.g., the correlation volume 235), which are obtained based on the initial SE3 motion T, into the search module 245 to obtain a correlation feature. The electronic device may input the correlation feature into the multi-head CGRU 250. The electronic device may input a context feature and a hidden state extracted by the context encoder 226 into the multi-head CGRU 250. The electronic device may generate a new hidden state based on the correlation feature, the context feature, and the hidden state that are input to the multi-head CGRU 250. At a subsequent iterative operation (e.g., an iterative operation after the iterative operation 260 of FIG. 2), the electronic device may input the new hidden state into the multi-head CGRU 250. Based on the new hidden state, the electronic device may generate a correction feature 440 (e.g., r), a confidence feature 430 (e.g., w), a motion embedding feature 420 (e.g., v^{M}), and a non-occluded-category label embedding feature 410 (e.g., v^{G}). The electronic device may use these generated features as inputs to the differentiable dense pose-level network layer 255. The electronic device may obtain an updated SE3 motion T through the differentiable dense pose-level network layer 255. Based on the updated SE3 motion T, the electronic device may obtain input data for a multi-head CGRU that is to be used for the subsequent iterative operation after the iterative operation (e.g., the iterative operation 260 of FIG. 2). For example, based on the updated SE3 motion T, the electronic device may obtain a flow field, a twist field, a depth residual, and a correlation feature to be used. The electronic device may combine (or concatenate) the context feature generated by the context encoder 226 and the new hidden state generated by the iterative operation (e.g., the iterative operation 260 of FIG. 2), and input a combination result into the multi-head CGRU. The electronic device may generate a new hidden state again through the multi-head CGRU used at a subsequent iterative operation after the iterative operation (e.g., the iterative operation 260 of FIG. 2).

The differentiable dense pose-level network layer 255 (e.g., a dense-spatial Euclidean 3 layer or a dense-SE3 layer) in the AI network 210 may be used to update the SE3 motion T. The electronic device may update the SE3 motion T through a Gauss-Newton iteration method, using the differentiable dense pose-level network layer 255. In this case, the electronic device may use the updated SE3 motion T to classify pixels in images (e.g., the first frame 201 and the second frame 202) into different object groups. The pixels corresponding to the different object groups may share the same SE3 motion T. That is, the electronic device may update the SE3 motion T with the differentiable dense pose-level network layer 255.

For example, a reprojection error-based cost function E^{δ}(δᵢ) may be defined as Equation 1 below.

$${α}_{( i j )} = 2 * σ ( - \vert \vert {v}_{i}^{H} - {v}_{j}^{H} {\vert \vert}^{2} ) \qquad Equation 1$$

$${E}^{δ} ( {δ}_{i} ) = {\sum }_{i ∈ Ω} {\sum }_{j ∈ {N}_{i}} {α}_{i j} {e}_{i j}^{2} ( {δ}_{i} )$$

$${e}_{ij}^{2} ( {δ}_{i} ) = \vert \vert {r}_{j} + π ( {T}_{j} {X}_{j} ) - π ( {e}^{{δ}_{i}} {T}_{i} {X}_{j} ) {\vert \vert}_{{w}_{j}}^{2}$$

In Equation 1, σ denotes a sigmoid function, i denotes each pixel, and j denotes each pixel in a neighboring point set Ni corresponding to i. Each pixel i and each corresponding pixel j in the neighboring point set may constitute one pixel point pair (i, j). α₍ᵢⱼ₎ denotes affinity, i.e., a matching degree, between points in the point pair. eᵢⱼ²(δᵢ) denotes a Mahalanobis distance corresponding to the point pair, which may also be referred to as an energy function. Tᵢ denotes SE3 motion information/pose corresponding to a pixel i, and Tⱼ denotes SE3 motion information corresponding to a pixel j. Xⱼ denotes 3D coordinate information of the pixel j, and rⱼ denotes a correction feature corresponding to the pixel j. wⱼ denotes a confidence feature corresponding to the pixel j. For example, the confidence feature may include a weight. e^{δ}^{ᵢ} denotes an SE3 motion increment corresponding to the pixel i. Based on the Gauss-Newton iteration method, the electronic device may obtain updated motion information corresponding to each pixel by minimizing a cost provided by executing code configured to execute as per the cost function expressed in Equation 1 above.

According to some embodiments, the electronic device may map a 3D point (e.g., X=(X, Y, Z)) to projected pixel coordinates and depth (e.g., x=(u, v, d)) corresponding to the 3D point X by an enhanced projection function π( ) based on Equation 1. Equation 1 above may imply that, for each pixel i, a single SE3 motion T needs to describe a motion of all the pixels j in the neighboring point set. However, since not all the pixels j in the neighboring point set belong to the same moving object, an embedding vector may be required. That is, a pixel pair (i, j) with similar embedding vector values may significantly contribute to the cost function (e.g., decrease a cost value according to the cost function). For the electronic device to obtain the embedding vector, an embedding feature vector based on both the motion embedding feature 420 (e.g., v^{M}) and the non-occluded-category label embedding feature 410 (e.g., v^{G}) may be used. The electronic device may thus fuse (e.g., concatenate) the two embedding features to obtain the fused embedding feature 460 (e.g., v^{H}).

The fused embedding feature 460 may be used to soft-group pixels into (1) a geometrically consistent non-occluded and in-boundary background region, (2) geometrically consistent non-occluded, in-boundary, dynamic object regions, and (3) other regions with a consistent motion. For one pixel pair (i, j), the electronic device may calculate an affinity α₍ᵢⱼ₎ corresponding to the pixel pair based on an L2 distance, given two fused embedding features 460 (e.g., vᵢ^{H} and vⱼ^{H}) corresponding to the respective pixels. For example, the affinity α₍ᵢⱼ₎ may satisfy α₍ᵢⱼ₎∈[0, 1]. In this case, an affinity value may also indicate a matching level between the pixels in the pixel pair.

According to some embodiments, the electronic device may obtain the updated SE3 motion by updating the SE3 motion T through an optimization method that minimizes the cost function E^{δ}(δᵢ) based on Equation 1 above. The electronic device may perform a subsequent iterative operation (e. g., iteration 2, iteration 3, . . . , and iteration N of FIG. 2) based on a new SE3 motion (e.g., the updated SE3 motion). The electronic device may obtain a target motion field by iteratively updating the motion field until the number of iterations reaches a predetermined N number of iterations or the motion field satisfies a predetermined convergence condition. N may be set based on an experimental value and/or empirical value.

The AI network 210 may include a 3D motion propagation module (e.g., the 3D motion propagation module 270 of FIG. 2).

An output from the differentiable dense pose-level network layer 255 (e.g., the dense-SE3 layer) in the electronic device may include a result calculated under the assumption that a pixel corresponding to a specific point of an object is displayed in both frame. That is, the dense-SE3 layer may accurately and robustly estimate the SE3 motion T of the entire image only with the above assumption. However, under the above assumption, the electronic device may inaccurately estimate a scene flow in a case where an object in two frames is occluded or moved outside a boundary of an image. Thus, the electronic device may propagate an estimated non-occluded and in-boundary scene flow value to an occluded and out-of-boundary scene flow value, respectively, by observing a high structural similarity (e.g., geometric consistency) between a scene flow and an image itself. That is, the electronic device may propagate the estimated non-occluded and in-boundary scene flow value to an occluded and out-of-boundary pixel based on a similarity of a feature itself, through a self-attention layer. Equation 2 below describes operations performed in the self-attention layer of the electronic device; code may be configured as per Equation 2 to perform the operations.

$$\tilde{T} = softmax ( \frac{F {F}^{T}}{\sqrt{D}} ) T \qquad Equation 2$$

In Equation 2, F denotes an attention feature (e.g., the third feature 370 of FIG. 3). That is, F denotes an image feature of a color image (e.g., the first color image 310 of FIG. 3) extracted through an attention encoder (e.g., the attention encoder 225 of FIG. 2). The electronic device may calculate a self-attention weight of the image feature. The electronic device may obtain a corrected weight

$$softmax ( \frac{F {F}^{T}}{\sqrt{D}} )$$

of a target motion field T (e.g., an SE3 motion obtained by iteratively performing the motion field update operation a predetermined number of times). By adjusting the target motion field T based on the corrected weight

$$softmax ( \frac{F {F}^{T}}{\sqrt{D}} ) ,$$

the electronic device may obtain an adjusted motion field \tilde{T}. Here, \sqrt{D} denotes a normalization factor for a result of a scalar product operation between F and F^{T}.

The electronic device may output a scene flow estimation result 280 based on the motion field \tilde{T}. For example, after obtaining the motion field \tilde{T}, the electronic device may divide \tilde{T} into rotational and translational components. Based on the rotational and translational components, the electronic device may estimate a 3D motion of an object in an image. The electronic device may also project the motion field \tilde{T} onto images of a frame pair to obtain a scene flow, i.e., an optical flow.

According to some embodiments, based on an RAFT-3D++ network (e.g., the AI network 210 of FIG. 2), the electronic device may extract features from color images I₁ and I₂ (e.g., the first color image 310 and the second color image 330 of FIG. 3) and depth images d₁ and d₂ (e.g., the first depth image 320 and the second depth image 340 of FIG. 3), which are respectively in two frames input to the RAFT-3D++ network. Based on the extracted features, the electronic device may build a 4D correlation volume 235 that represents visual similarities between pixels of all pixel pairs in the two input frames. The electronic device may also initialize a correlation state based on the extracted features. For example, the electronic device may obtain the identity (or sameness) of the pixels in the respective input images when the search module 245 starts being executed based on initializing an SE3 motion T. For example, the electronic device may allow a multi-task CGRU to perform an iterative operation based on initializing a context feature and a hidden state. For example, the electronic device may propagate the SE3 motion based on initializing an attention feature of an attentional model. At each iterative operation of updating the motion field, the search module 245 may index a correlation feature set in the correlation volume 235 by estimating a current SE3 motion. The electronic device may use the correlation feature and the hidden state to generate a correction feature 440, a confidence feature 430, and a fused embedding feature 460 of a scene flow. The electronic device may input the correction feature 440, the confidence feature 430, and the fused embedding feature 460 into the differentiable dense pose-level network layer 255 (e.g., the dense-SE3 layer). The differentiable dense pose-level network layer 255 may include a least square optimization layer that generates an updated result for the SE3 motion estimation with geometric constraints.

At each iterative operation of updating the motion field, the electronic device may use a currently estimated value of the SE3 motion to build an index for the correlation feature set in the 4D correlation volume 235. The electronic device may input the correlation volume 235 with the index built for the correlation feature set into the multi-head CGRU 250 (or a multi-head ConvGRU) to obtain the correlation feature. For example, the electronic device may generate the correction feature 440, the confidence feature 430, and the fused embedding feature 460 of the scene flow. The electronic device may generate an updated SE3 motion (e.g., a pose-level motion 470 (e.g., Tᵢⱼ) of FIG. 4) based on the differentiable dense pose-level network layer 255. The electronic device may propagate an SE3 motion corresponding to a non-occluded and (and/or in-boundary) pixel to an occluded (and/or out-of-boundary) pixel by measuring a self-similarity of a feature based on an attention module (e.g., the 3D motion propagation module 270 of FIG. 2). Also, the electronic device may propagate an SE3 motion corresponding to an in-boundary pixel to an out-of-boundary pixel by measuring a self-similarity of a feature based on an attention module (e.g., the 3D motion propagation module 270 of FIG. 2).

According to some embodiments, the electronic device may perform an iterative operation using the RAFT-3D++ network. At each iterative operation, the search module 245 in the electronic device may index the correlation feature set in the 4D correlation volume 235 using a currently estimated SE3 motion. At each iterative operation (e.g., the iteration 260 of FIG. 2), the electronic device may use a correlation feature, a context feature, and a hidden state to generate the correction feature 440 (e.g., r), the confidence feature 430 (e.g., w), and the fused embedding feature 460 (e.g., v^{H}) of the scene flow. The fused embedding feature 460 may be generated based on a feature concatenation operation 450 on the non-occluded-category label embedding feature 410 (e.g., v^{G}) and the motion embedding feature 420 (e.g., v^{M}). The electronic device may generate an updated SE3 motion T (e.g., the pose-level motion 470 (e.g., Tᵢⱼ)) through the geometric constraints, based on inputting the correction feature 440 (e.g., r), the confidence feature 430 (e.g., w), and the fused embedding feature 460 (e.g., v^{H}) into the differentiable dense pose-level network layer 255. The electronic device may iterate the process described above. After a predetermined number of iterations, the electronic device may input the pose-level motion 470 (e.g., Tᵢⱼ) into a 3D motion propagation module (e.g., the 3D motion propagation module 270 of FIG. 2). The 3D motion propagation module may propagate an SE3 motion of a non-occluded and in-boundary pixel to an occluded and out-of-boundary pixel by measuring a self-similarity of each of the features. In other words, the electronic device may use the 3D motion propagation module to propagate 3D motion information of a region that is easy to estimate in an image to 3D motion information of a region that is difficult to estimate in the image.

The electronic device may obtain a dense, robust, and accurate SE3 motion based on iteratively updating a motion field a predetermined number of times. The SE3 motion may be divided into a rotational component and a translational component. The electronic device may obtain an optical flow and a scene flow by projecting the SE3 motion onto an image.

FIG. 5 illustrates an example of a method performed by an electronic device to train an AI network according to one or more example embodiments.

An AI network described herein (e.g., the AI network 210 of FIG. 2) may include a neural network trained with a training set.

According to some embodiments, at operation 510, the electronic device may obtain an AI network to be trained and a training set. The training set obtained by the electronic device may include a GT scene flow value and a GT geometric segmentation mask value corresponding to a sample frame pair. For reference, the GT geometric segmentation mask value may also be referred to herein as a GT non-occluded-category label mask value. Each sample frame in the sample frame pair may include a color image and a depth image corresponding to the color image. The GT geometric segmentation mask value may refer to a value that characterizes a category of an object corresponding to a pixel pair in the sample frame pair. Further, the pixel pair may refer to a pair including a pixel (e.g., a first pixel) of first sample frame of the sample frame pair and a pixel (e.g., a second pixel) corresponding to the first pixel among pixels in second sample frame of the sample frame pair.

According to some embodiments, at operation 520, the electronic device may, based on the training set, iteratively perform a training operation until a predetermined training end condition for the AI network to be trained is satisfied. The electronic device may obtain a trained AI network by iteratively training the AI network to be trained. The training operation performed by the electronic device may include, for each sample frame pair, obtaining a motion embedding feature and a non-occluded-category label embedding feature corresponding to the sample frame pair, using the AI network. The training operation may include obtaining an estimated scene flow value corresponding to the sample frame pair, based on the obtained motion embedding feature and the obtained non-occluded-category label embedding feature. The training operation may include obtaining an estimated non-occluded-category label mask value of the sample frame pair, based on the non-occluded-category label embedding feature. In this case, the non-occluded-category label embedding feature represents a value that characterizes category information corresponding to a pixel pair in the sample frame pair. The training operation may include determining a first training loss based on the GT scene flow value and the estimated scene flow value corresponding to the sample frame pair. The training operation may include obtaining a second training loss based on the GT non-occluded-category label mask value and the estimated non-occluded-category label mask value corresponding to the sample frame pair. The training operation may include determining a combined training loss based on the first training loss and the second training loss, and adjusting a model parameter of the AI network based on the combined training loss.

For reference, the method described with reference to FIG. 5 represents a method performed by the electronic device to train an AI network (e.g., the AI network 210 of FIG. 2). The electronic device performing the method described with reference to FIG. 5 may be the same as or different from the electronic device performing the method described above with reference to FIG. 1.

A method of obtaining a training sample in the training set of the AI network by the electronic device is not limited to a specific one. The training sample may include labeled images for supervised learning. A labeled image may include a GT scene flow value and a GT geometric segmentation mask value corresponding to a sample frame pair. The GT geometric segmentation mask value represents an actual category corresponding to an object and/or region in the frame pair in the training set. In this case, objects and/or regions in the same category may have the same pose. For example, in a case where there are three categories of objects (e.g., two moving non-occluded objects and a non-occluded background region) in a sample frame pair, a GT geometric segmentation mask value of the sample frame pair may include three mask maps. In this case, objects corresponding to one category may correspond to one mask map. A mask map may be a feature map consisting of two values such as 1 and 0, for example. The size of the mask map may be the same as the size of sample frame (e.g., a sample image). Of pixels in a mask map, pixels with a value of 1 may indicate that the pixels correspond to an object of the mask's type. In contrast, of the pixels in a mask map, pixels with a value of zero (0) may indicate that the pixels do not correspond to the object type of the mask. Accordingly, the electronic device may determine a result of grouping pixels of the sample frame pair based on the GT geometric segmentation mask value of the sample frame pair. The electronic device may perform supervised learning on the AI network based on the GT values (e.g., the GT non-occluded-category label mask value and the GT scene flow value). The electronic device may use the AI network obtained through the supervised learning to accurately extract a non-occluded-category label embedding feature corresponding to a frame pair to be processed and obtain a more accurate scene flow estimation result based on the extracted non-occluded-category label embedding feature.

According to some embodiments, in such a training phase for the AI network, the electronic device may obtain a non-occluded-category label embedding feature corresponding to a sample frame pair by inputting the sample frame pair into the AI network. Based on the obtained non-occluded-category label embedding feature, the electronic device may obtain an estimated non-occluded-category label mask value of the sample frame pair. The electronic device may calculate the second training loss corresponding to a mask loss, based on a difference between the estimated non-occluded-category label mask value and a GT non-occluded-category label mask value.

For example, for each pixel in the sample frame pair, the electronic device may use a non-occluded-category label embedding feature value corresponding to a pixel in the sample frame pair as an estimated non-occluded-category label mask value corresponding to the pixel.

For a sample frame pair, the electronic device may obtain an estimated non-occluded-category label mask value of the sample frame pair, based on a non-occluded-category label embedding feature of the sample frame pair. For example, the electronic device may determine a category corresponding to each pixel in the sample frame pair based on a GT non-occluded-category label mask value of the sample frame pair. Based on the non-occluded-category label embedding feature of pixels corresponding to the category, the electronic device may determine an average non-occluded-category label feature for the pixels corresponding to the category. For example, for each of pixels in the first sample frame, the electronic device may determine an estimated non-occluded-category label mask value for a pixel corresponding to the category, based on a difference between a non-occluded-category label embedding feature corresponding to the pixel and the average non-occluded-category label feature for the pixels corresponding to the category to which the pixel belongs.

In this case, a greater difference between the non-occluded-category label embedding feature corresponding to the pixel and the average non-occluded-category label feature for the pixels corresponding to the category to which the pixel belongs may indicate that the pixel has a pixel value indicating a relatively low probability of the pixel belonging to the category. For example, a GT non-occluded-category label mask value corresponding to the pixel may include zero (0) or 1. An estimated non-occluded-category label mask value corresponding to the pixel may also be 0 or 1, or a value normalized to a value between [0, 1]. As described above, as the difference between the non-occluded-category label embedding feature corresponding to the pixel and the average non-occluded-category label feature for the pixels corresponding to the category to which the pixel belongs increases, the estimated non-occluded-category label mask value may decrease.

According to some embodiments, the electronic device may combine the second training loss (e.g., a mask loss) corresponding to each sample frame pair and the first training loss (e.g., a scene flow estimation loss) of each sample frame pair to obtain a combined training loss of the AI network. The electronic device may adjust parameters (e.g., weights) of the AI network based on the combined training loss. The electronic device may obtain the trained AI network by iteratively training the AI network until the training end condition (e.g., when the combined training loss converges or when the number of training iterations reaches a predetermined number of iterations) is satisfied.

According to some embodiments, in the training phase, the electronic device may obtain a scene flow estimation result corresponding to a sample frame pair based on a motion embedding feature and a non-occluded-category label embedding feature of the sample frame pair. For example, the electronic device may obtain, by the AI network, the motion embedding feature and the non-occluded-category label embedding feature corresponding to the sample frame pair, based on a motion field corresponding to the sample frame pair. The electronic device may obtain a fused embedding feature in which the motion embedding feature and the non-occluded-category label embedding feature are fused. The electronic device may update the motion field corresponding to the sample frame pair based on the fused embedding feature to minimize a reprojection error between pixels of a pixel pair in the sample frame pair. The electronic device may obtain a target motion field by iteratively updating the motion field corresponding to the sample frame pair a predetermined number of times based on the fused embedding feature. Based on the target motion field, the electronic device may obtain the scene flow estimation result corresponding to the sample frame pair.

According to some embodiments, the electronic device may obtain an initial motion field corresponding to the sample frame pair. Based on the initial motion field, the electronic device may iteratively update the motion field by the AI network. The electronic device may use the updated motion field for a subsequent iterative update operation. For example, the electronic device may use a first motion field generated in a first motion field update operation as an input to a second motion field update operation. The electronic device may obtain a scene flow corresponding to the sample frame pair based on iteratively updating the motion field a predetermined number of times. In other words, the electronic device may obtain an estimated scene flow value of the sample frame pair through the AI network. A detailed process in which the electronic device obtains the scene flow corresponding to the sample frame pair in the training phase may be generally the same as the process in which the electronic device obtains the scene flow corresponding to the frame pair through the trained AI network described above with reference to FIGS. 2 through 4.

According to some embodiments, the electronic device may obtain a weight for the sample frame pair that adjusts the motion field, based on a similarity level between pixels in a sample color image of the sample frame pair. For example, the electronic device may obtain a motion field adjustment weight and/or a scene flow correction weight, based on a similarity level between pixels in a first sample color image in the sample frame pair.

Based on the obtained weight, the electronic device may adjust the target motion field corresponding to the sample frame pair. Based on the adjusted target motion field, the electronic device may obtain the scene flow estimation result of the sample frame pair.

For reference, the scene flow correction weight may be implemented using a self-attention mechanism. For example, the electronic device may calculate a self-attention weight corresponding to a color image by using, as an input feature for the attention mechanism, an image feature corresponding to a feature of the color image, and may use the calculated self-attention weight as the scene flow correction weight.

A method by which the electronic device obtains a GT non-occluded-category label mask value of a sample frame pair is not limited to a specific one. For example, the electronic device may obtain the GT non-occluded-category label mask value of the sample frame pair based on a user input. For reference, the GT non-occluded-category label mask value may also be referred to herein as a GT geometric segmentation mask value.

According to some embodiments, to reduce the labor cost required to obtain a training data sample for training the AI network and improve efficiency, the electronic device may obtain an object instance segmentation result of a corresponding sample frame pair. The electronic device may determine a first optical error between matched pixels of a pixel pair in the sample frame pair, based on a GT scene flow value of the sample frame pair. Based on the first optical error and the object instance segmentation result, the electronic device may determine a GT non-occluded-category label mask value (e.g., m^{obj} to be described later) corresponding to an object instance in the sample frame pair. Based on the GT non-occluded-category label mask value corresponding to the object instance, the electronic device may obtain a GT non-occluded-category label mask value of the sample frame pair.

For reference, the object instance segmentation result of the sample frame pair may indicate which object instance is present in the sample frame pair. For example, the object instance may include a dynamic object and a static object. The object instance may also include a background of an image (i.e., a background may be treated, logically, as a form of object). Based on the object instance segmentation result, the electronic device may determine which pixels in the frame pair belong to same objects.

The GT scene flow value of the sample frame pair may be a known value. Accordingly, the electronic device may calculate, based on the GT scene flow value, the first optical error between the pixels of the pixel pair in the sample frame pair (e.g., an optical error between a pixel in the first frame and a pixel corresponding to a position at which the pixel in the first frame is projected onto the second frame). In this case, which pixels in the sample frame pair belong to the same object instance may be known in advance. Based on the first optical error, the electronic device may determine a GT non-occluded-category label mask value corresponding to each object instance. In other words, the electronic device may determine which pixel belongs to which object instance. For example, in a case where, for any one pixel, the pixel belongs to one object instance and a first optical error corresponding to the pixel is less than or equal to a first threshold value, the electronic device may determine that the pixel actually belongs to the object instance. The electronic device may determine a GT mask value corresponding to the pixel in a feature map corresponding to a GT non-occluded-category label mask value corresponding to the object instance to be 1, or 0 otherwise. The electronic device may obtain a GT non-occluded-category label mask value corresponding to each object instance in this way.

According to some embodiments, the electronic device may use the obtained GT non-occluded-category label mask value of each object instance as a GT non-occluded-category label mask value of a corresponding sample frame pair for training the AI network. However, when the electronic device estimates a scene flow based on a frame pair of two successive frames, some object instances among multiple object instances present in the frame pair may be an object instance that rarely changes in the frame pair of the two successive frames. For example, a frame pair of two successive frames input to the electronic device may include a static object instance, such as, a background of an image or a static house. Based on a case where an input sample frame pair includes a static object instance, the electronic device may obtain a GT non-occluded-category label mask value corresponding to the sample frame pair. For example, the electronic device may obtain a GT motion field value corresponding to the sample frame pair. Based on the GT motion field value corresponding to the sample frame pair, the electronic device may determine a second optical error and a depth error between matched pixels of a pixel pair in the sample frame pair. Based on the second optical error and the depth error, the electronic device may determine a GT non-occluded-category label mask value (m^{static} to be described later) corresponding to a non-occluded background region in the sample frame pair. The electronic device may obtain a fused GT non-occluded-category label mask value in which the GT non-occluded-category label mask value corresponding to the non-occluded background region and a GT non-occluded-category label mask value corresponding to each object instance are fused.

For reference, the GT motion field value and a depth image of the sample frame pair may have known values. Accordingly, based on the predetermined GT motion field value and depth image of the frame pair, the electronic device may accurately calculate the second optical error and the depth error fused with an actual position and depth information of the pixel pair. In addition, based on the predetermined GT motion field value and depth image of the frame pair, the electronic device may accurately distinguish a non-occluded and in-boundary background region in the frame pair and obtain a GT non-occluded-category label mask value corresponding to the background region.

According to some embodiments, in a case where, for any pixel pair, the second optical error corresponding to a corresponding pixel pair is less than a predetermined second threshold value and the depth error corresponding to the pixel pair is less than a predetermined third threshold value, the electronic device may determine that the pixel pair belongs to a non-occluded and in-boundary background region. Accordingly, the electronic device may determine a GT mask value corresponding to the pixel pair to be 1, or zero (0) otherwise. In this way, the electronic device may obtain a GT non-occluded-category label mask value map corresponding to the non-occluded and in-boundary background region.

According to some embodiments, when the electronic device obtains a GT non-occluded-category label mask value map corresponding to each object instance in an input frame pair and a GT non-occluded-category label mask value map corresponding to a non-occluded and in-boundary background region, the electronic device may obtain a fused GT value map by fusing the obtained GT value maps. The electronic device may determine the fused GT value map to be a final GT non-occluded-category label mask value map of the sample frame pair to be used to train the AI network. For example, in a case where a pixel having a value of 1 in a GT non-occluded-category label mask value map corresponding to one or some object instance also has a value of 1 in a GT non-occluded-category label mask value map corresponding to a background region, the electronic device may remove the GT non-occluded-category label mask value map corresponding to the object instance. In other words, the electronic device may determine that the object instance belongs to a background region category. For example, suppose there are five object instances in one sample frame pair. In this example, the electronic device may obtain GT non-occluded-category label mask value maps corresponding to the five object instances and a GT non-occluded-category label mask value map corresponding to a background region. In this case, when the electronic device determines that GT non-occluded-category label mask value maps corresponding to two object instances of the five object instances are occluded by the GT non-occluded-category label mask value map corresponding to the background region (for example, when pixels in the GT non-occluded-category label mask value map corresponding to the background region occlude a region of pixels having a value of 1 in the GT non-occluded-category label mask value maps corresponding to the object instances), the electronic device may determine that finally obtained GT non-occluded-category label mask value maps corresponding to the object instances are a GT mask value map corresponding to four categories. That is, the electronic device may determine the GT non-occluded-category label mask value map corresponding to the background region and GT non-occluded-category label mask value maps corresponding to the remaining three object instances to be the finally obtained non-occluded-category label mask value maps. The electronic device may distinguish between each of the three object instances and the background region to recognize a total of four categories.

According to some embodiments, the electronic device may train the AI network based on combining optimized losses (e.g., the first training loss and the second training loss). For example, the electronic device may combine a GT optical flow and a depth change to train the AI network through supervised learning. The electronic device may also use a geometric segmentation mask to train the AI network through supervised learning. A method by which the electronic device trains the AI network through supervised learning is described in detail below with reference to FIG. 6.

FIG. 6 illustrates an example of a method performed by an electronic device to obtain training losses to train an AI network according to one or more example embodiments.

According to some embodiments, the electronic device may calculate an error between an estimated scene flow value and a predetermined GT value to train the AI network 210 through supervised training. For example, the electronic device may calculate a scene flow loss 620. The scene flow loss 620 may also be referred to herein as a first training loss. Hereinafter, a method of obtaining a scene flow loss is described in detail.

According to some embodiments, the electronic device may output an SE3 motion (e.g., a 3D motion 601 of a preceding iteration and an updated 3D motion 602) from the AI network 210. For example, the electronic device may output a series of T₁, T₂, . . . , T_{K} corresponding to the SE3 motion by inputting a frame pair into the AI network 210. In this example, K denotes the number of object instances in the frame pair, and T_{K} denotes an SE3 motion of a Kth object instance, where K is greater than or equal to 2. Based on each T_{K}, the electronic device may calculate an optical flow and a depth change according to a corresponding object instance, i.e., fₖ^{est}=π(Tₖπ⁻¹(x))−x, where x represents a corresponding relationship between a pixel and a dense pixel in the frame pair. For example, the first frame in the frame pair may include a first pixel, while the second frame in the frame pair may include a second pixel. The second pixel may correspond to the first pixel. In this case, a dense pixel can refer to the pixels densely clustered around the second pixel. The electronic device may calculate the scene flow loss 620 (e.g., L_{flow}) by executing code configured as per Equation 3 below for calculating an L1 distance.

$${L}_{flow} = \vert \vert {f}^{gt} - {f}^{e s t} {\vert \vert}_{1} \qquad Equation 3$$

In Equation 3, f^{gt} denotes a GT scene flow value corresponding to a sample frame pair input to the AI network 210. f^{est} denotes an estimated scene flow value output from the AI network 210. That is, the electronic device may obtain the estimated scene flow value f^{est} by performing a projection operation 630 to project the updated 3D motion 602 (e.g., a target motion field corresponding to the sample frame pair) obtained based on the AI network 210 onto sample frame (e.g., a sample image). Accordingly, the electronic device may calculate the scene flow loss 620 based on the GT scene flow value and the estimated scene flow value. For reference, the scene flow loss 620 may also be referred to as scene flow supervision.

According to some embodiments, the electronic device may calculate a mask loss 610 for supervised learning for the AI network 210. The mask loss 610 may also be referred to as a second training loss or a non-occluded-category label mask loss. The electronic device may help the AI network 210 learn a non-occluded-category label embedding feature 410 (e.g., v^{G}∈R^{D×H×W}) based on the mask loss 610 for each pixel corresponding to the input frame pair. In this case, D denotes the number of channels of an image in the input frame pair, H denotes the height of the image in the input frame pair, and W denotes the width of the image in the input frame pair. Based on a predetermined GT non-occluded-category label mask value mₖ^{gt}∈{0, 1}^{H×W}, the electronic device may first calculate an average embedding, tₖ∈R^{D}, corresponding to each category (e.g., k∈{1, 2, . . . , K}), by executing code/instructions configured as per Equation 4 below. For reference, the average embedding may represent an average non-occluded-category label embedding.

$${t}_{k} = \frac{1}{\vert {m}_{k}^{gt} {\vert}_{1}} {\sum }_{H , W} {m}_{k , h , w}^{gt} {v}_{: , h , w}^{G} \qquad Equation 4$$

In Equation 4, assuming that the average non-occluded-category label embedding t_{K} represents an average value of K GT non-occluded-category label mask values (e.g., non-occluded-category label embedding features corresponding to the K categories), k denotes one category (e.g., a geometrically consistent non-occluded static background region, a geometrically consistent non-occluded dynamic object region, or an occluded and/or out-of-boundary region). |mₖ^{gt}|₁ denotes a sum of all values in a GT non-occluded-category label mask value map of category k. That is, |mₖ^{gt}|₁ denotes the number of all pixels corresponding to a value of 1 among pixels in the GT non-occluded-category label mask value map. v_{:,h,w}^{G} denotes the non-occluded-category label embedding feature 410 corresponding to the sample frame pair estimated by the AI network 210. m_{k,w,h}^{gt} denotes a GT non-occluded-category label mask value (0 or 1) corresponding to any one pixel belonging to category k. tₖ denotes an average value of non-occluded-category label embedding features corresponding to all the pixels belonging to category k. The electronic device may perform an operation of determining an object in the frame pair based on the non-occluded-category label embedding feature v_{:,h,w}^{G} and the average non-occluded-category label embedding tₖ corresponding to each category. Based on the non-occluded-category label embedding feature and the average non-occluded-category label embedding, the electronic device may calculate the mask loss 610 (e.g., Lₘₐₛₖ), by executing code/instructions configured as per Equation 5 below.

$${m}_{k}^{est} = Sigmoid ( - \vert \vert {v}_{: , h , w}^{G} - {t}_{k} {\vert \vert}_{2} ) \qquad Equation 5$$

$${L}_{mask} = \vert \vert - ( {m}^{gt} log ( {m}^{est} ) + ( 1 - {m}^{g t} ) log ( 1 - {m}^{est} ) ) {\vert \vert}_{1}$$

Based on Equation 5, for each category k, the electronic device may obtain an estimated non-occluded-category label mask value mₖ^{est} corresponding to a corresponding category for each pixel, based on a difference between an average non-occluded-category label embedding feature tₖ of the corresponding category and a non-occluded-category label embedding feature v_{:,h,w}^{G} corresponding to each pixel belonging to the category obtained through the AI network 210. In Equation 5, the difference between the non-occluded-category label embedding feature v_{:,h,w}^{G} and the average non-occluded-category label embedding feature tₖ may be calculated based on an L2 distance between the two.

The electronic device may then calculate a cross-entropy loss between a GT non-occluded-category label mask value m^{gt} and an estimated non-occluded-category label mask value m^{est} corresponding to each sample frame pair to obtain the mask loss 610.

According to some embodiments, the electronic device may obtain a GT non-occluded label mask value corresponding to a sample frame pair, based on color images I₁ and I₂, depth images D₁ and D₂, a GT scene flow value f^{gt}, two camera poses T₁ and T₂, and a GT object instance label value O^{gt} of the sample frame pair that are predetermined. The electronic device may calculate intensity and/or optical consistency of each object in an image through a pair of color images and an actual scene flow. The electronic device may distinguish between an occluded region and a non-occluded region based on the intensity consistency. The electronic device may distinguish between the occluded region and the non-occluded region of each object instance, based on the occluded region, the non-occluded region, and the GT object instance label value O^{gt}.

According to some embodiments, the electronic device may calculate an optical error for each object instance k. Based on the calculated optical error, the electronic device may determine a GT mask value corresponding to each object instance. In this case, in response to the error being less than a predetermined threshold value, the electronic device may determine that a pixel of a corresponding object instance is non-occluded. Accordingly, the electronic device may obtain a GT object instance mask value m^{obj} corresponding to the sample frame pair based on code configured as per Equation 6 below. In this case, whether the object instance is static or dynamic may be not-considered (disregarded).

Based on the two color images I₁ and I₂ of the sample frame pair, the GT scene flow value f^{gt}, and the GT object instance label value O^{gt} (e.g., a result value from segmenting object instances in the sample frame pair), and the GT object instance mask value m^{obj} of a geometrically consistent non-occluded and in-boundary object region (e.g., a non-occluded object instance region), the electronic device may execute configured to calculate the optical error E^{p} (e.g., the first optical error); the code configured as expressed in Equation 6. In this case, k denotes an object instance index.

$${E}^{p} ( x ) = \vert \vert {I}_{i} ( x ) - {I}_{j} ( x + {f}^{gt} ) {\vert \vert}_{2} \qquad Equation 6$$

$${m}^{obj} ( x ) = \{ {k {E}^{p} ( x ) <}_{0} {Th}_{1} and {{o}^{g t} ∈ \{ 1 , … , k , … K \}}_{Others}$$

In Equation 6, I₁(x) denotes a pixel value corresponding to a pixel x in a first sample color image. I₂(x+f^{gt}) denotes a pixel value corresponding to the pixel x among pixels in a second sample color image obtained based on a GT scene flow value. ∥·∥₂ denotes an L2 distance. Th₁ denotes a predetermined first threshold value. o^{gt}∈{1, . . . , k, . . . K}denotes an object instance corresponding to index k. Equation 6 represents the following. For example, in a case where an optical error E^{p} corresponding to a pixel is less than the first threshold value, and the pixel is a pixel of an object instance corresponding to index k, a GT mask value of a position corresponding to the pixel in a GT object instance mask value m^{obj} of the object instance may be k, or zero (0) otherwise.

Through Equation 6 above, the electronic device may obtain a GT mask value corresponding to each object instance.

According to some embodiments, the electronic device may train the AI network 210 by considering a case where a static object (or static region) in an image has a global motion. For reference, the global motion may represent a case where a static object (e.g., a tree, a building, etc.) in an image appears to move as a camera that captures the image moves at the time of capturing the image. Thus, the global motion of a static object may correspond to a change in camera pose. The electronic device may train the AI network 210 such that the AI network 210 distinguishes between scene flow estimation for a dynamic object in an image (one moving in the physical world relative to static/stationary parts of the physical scene) and scene flow estimation for a static object in the image. For example, the electronic device may calculate an optical error and a depth error for each pose based on a predetermined GT camera pose value (e.g., a camera movement and a camera position). For example, in a case where a frame pair is captured with a camera motion included, an object instance in the frame pair may be a static object, a dynamic object, or an object of a different nature (e.g., an object that is present in first frame but is occluded or located outside an image boundary in second frame). Thus, the electronic device may obtain depth images D₁ and D₂ and two GT camera pose values T₁ and T₂ to train the AI network 210. Based on the depth images D₁ and D₂ and the GT camera pose values T₁ and T₂, the electronic device may calculate the optical error (e.g., the second optical error) and the depth error, by executing code/instructions configured as per Equation 7 below.

$$\begin{matrix}{E}^{p} ( x ) = \vert \vert {I}_{1} ( x ) - {I}_{2} ( π ( {T}_{2} {T}_{1}^{- 1} {π}^{- 1} ( x , {d}_{1} ) ) ) {\vert \vert}_{2} \\ {E}^{d} ( x ) = \vert \vert D ( π ( {T}_{2} {T}_{1}^{- 1} {π}^{- 1} ( x , {d}_{1} ) ) ) - {d}_{2} ( π ( {T}_{2} {T}_{1}^{- 1} {π}^{- 1} ( x , {d}_{1} ) ) ) {\vert \vert}_{2}\end{matrix} \qquad Equation 7$$

In Equation 7, D(π(TⱼTᵢ⁻¹π⁻¹(x, dᵢ))) denotes a depth of a pixel x′ (e.g., a second pixel among pixels in second sample frame that corresponds to a first pixel in first sample frame) corresponding to a pixel x (e.g., the first pixel in the first sample frame) calculated based on a camera pose and a depth. d₂(π(T₂T₁⁻¹π⁻¹(x, d₁))) denotes a depth value calculated from a second sample depth image of the second sample frame based on pixel coordinates of the pixel x′. The remaining parameters of Equation 7 have been described above with reference to Equation 6.

After calculating the optical error and the depth error, the electronic device may calculate a GT mask value map corresponding to a non-occluded background region. In other words, the electronic device may calculate a GT mask value m^{static} corresponding to a geometrically consistent non-occluded background and/or static object, based on the optical error E^{p} and the depth error E^{d}, executing code configured per Equation 8 below.

$${m}^{static} ( x ) = \{ {1 {E}^{p} ( x ) <}_{0} {Th}_{2} and {{E}^{d} ( x ) < T {h}_{3}}_{Others} \qquad Equation 8$$

In Equation 8, Th₂ denotes a second threshold value, and Th₃ denotes a third threshold value. The second threshold value and the third threshold value may be predetermined based on experimental and/or empirical values. For example, in a case where the depth error E^{d} corresponding to a pixel pair is less than a predetermined threshold (e.g., the third threshold value), the electronic device may determine that the pixel pair corresponds to a static object in a frame pair. For example, in a case where the optical error E^{p} corresponding to the pixel pair is less than a predetermined threshold (e.g., the second threshold value), the electronic device may determine that the pixel pair is not occluded or is inside a boundary. Accordingly, in a case where the depth error E^{d} and the optical error E^{p} corresponding to the pixel pair are less than the respective predetermined threshold values, the electronic device may determine the pixel pair as a non-occluded and in-boundary static pixel pair. That is, the electronic device may determine that the pixel pair belongs to a background region.

Based on the GT object instance mask value m^{obj} and the GT mask value m^{static} corresponding to a static object, the electronic device may obtain the GT non-occluded-category label mask value m^{gt} by executing code configured as expressed in Equation 9 below.

$${m}^{gt} = \{ \begin{matrix}k & {m ( x )}^{static} ( x ) = 0 and {m}^{obj} ( x ) ∈ \{ 1 , . , k , . , K \} \\ K + 1 & {m}^{static} ( x ) = 1 \\ 0 & Others\end{matrix} \qquad Equation 9$$

For reference, objects (or scenes) in an image may be classified into three categories (e.g., a first object, a second object, and a third object). For example, the first object category may be for non-occluded dynamic object instances (e.g., a person in motion or a moving object) that moves independently. For example, the second object category may be for non-occluded static region(s). For example, the non-occluded static region(s) may include a non-occluded background region and a non-occluded static object instance. According to some embodiments, the electronic device may recognize each of the non-occluded dynamic object instances, the non-occluded background region, and the non-occluded static object instances as instances in one category. In this case, all pixels corresponding to one category may have a consistent global motion. For example, the third object may represent an occluded region (e.g., m^{gt}=0 in Equation 9). For example, the occluded region may represent an object that is visible in only one image of a pair of images captured at different time points. In other words, the occluded region may have a pixel visible in only one of the images in a frame pair. The electronic device may train the AI model to output a non-occluded dynamic object instance embedding (e.g., an embedding vector) based on a GT non-occluded-category label mask value m^{gt}. For example, the electronic device may perform supervised learning using an average embedding-assisted non-occluded-category label mask m^{gt}.

According to some embodiments, the electronic device may input each training sample (e.g., first sample frame and second sample frame) in a training set (e.g., a sample frame pair) into the AI network 210 to calculate an estimated scene flow value and an estimated mask value corresponding to each sample frame (e.g., sample image). The electronic device may calculate a scene flow loss and a mask loss, based on comparing the estimated scene flow value and the estimated mask value to a predetermined GT scene flow value and a predetermined GT mask value corresponding to each training sample (e.g., the first sample frame and the second sample frame) in the training set (e.g., the sample frame pair), respectively. The electronic device may obtain a combined training loss from these two losses. For example, the combined training loss may represent a weighted sum of the scene flow loss and the mask loss. In this case, weights respectively corresponding to the two losses may be predetermined or set based on experimental or empirical values. For example, in Equation 10 below, hyperparameter weights w1 and w2 may be set to 1.0 and 0.1, respectively, and the combined training loss L may be calculated by executing code configured as per Equation 10.

$$L = w 1 * {L}_{flow} + w 2 * {L}_{mask} \qquad Equation 10$$

In Equation 10, L_{flow} and Lₘₐₛₖ denote, respectively, a scene flow loss and a mask loss corresponding to a training sample used by the electronic device for each iteration of training the AI network 210.

According to some embodiments, a scene flow estimation method performed by the electronic device may maximize matching accuracy, thus allowing the electronic device to perform nonlinear optimization, thereby enabling more accurate and robust pose estimation. The electronic device may estimate/infer not only a background region, but also a rigid dynamic object, a non-rigid object, an occluded region, and an out-of-boundary region. The electronic device may perform different estimation methods for different regions to accurately estimate a scene flow within an entire image. For example, the electronic device may use a geometric segmentation mask (or a “non-occluded-category label mask” herein) to accurately distinguish between a non-occluded and in-boundary background region and each non-occluded and in-boundary rigid object. For example, the electronic device may use the geometric segmentation mask to supervise a non-occluded-category label embedding feature, and input a fused embedding feature into a dense-SE3 layer to estimate SE3 motions in these regions. The electronic device may also use an attention module to propagate an SE3 motion in a non-occluded region to an occluded region, thereby optimizing the SE3 motion in the occluded region. Also, the electronic device may use an attention module to propagate an SE3 motion in an in-boundary region to out-of-boundary region, thereby optimizing the SE3 motion in the out-of-boundary region.

According to some embodiments, the AI network 210 may also be referred to as RAFT-3D++. For example, the electronic device may use the AI network 210 to estimate pixel-level 3D motion information of a frame pair (e.g., a pair of RGB-D video frames) of frames that that each include color information and depth information. For example, the electronic device may consider accurate matching or correspondence between densely populated pixels, such as, 3D geometric consistency of an object in the frame pair and an instance (or “object instance” herein) consistency (e.g., since a rigid motion embedding feature is not supervised in the training phase, it may be easy to disrupt the 3D geometric consistency and the instance consistency of the object in the frame pair, which may reduce the pixel matching quality of an occluded region). The 3D geometric consistency and the instance consistency of the object in the frame pair may be helpful to improve the matching quality of a pixel pair in an end-to-end AI network. The electronic device may use a new AI network (e.g., the AI network 210) based on RAFT-3D. For example, the electronic device may train the AI network 210 with fused embedding feature representations to group pixels with similar embedding features in the frame pair. The electronic device may train the AI network 210 based on a GT training mask value. The electronic device may classify mask values of the pixels into pixels of a mask, based on the 3D geometric consistency of the object in the frame pair (the frames captured at different time points) and the instance consistency with a neighboring region. Using the mask, the electronic device may perform high-quality matching on pixels in one frame of the frame pair to pixels in the other frame of the frame pair. Accordingly, the electronic device may minimize reprojection errors of pixels that may occur regardless of whether the pixels correspond to rigid dynamic objects and/or static background in their frames. Additionally, the AI network 210 may include an attention mechanism (e.g., the attention encoder 225 and the 3D motion propagation module 270 of FIG. 2). Based on the attention mechanism in the AI network 210, the electronic device may propagate a reliable and accurate 3D motion of a pixel in a non-occluded and in-boundary mask to a pixel in an occluded or texture-free region.

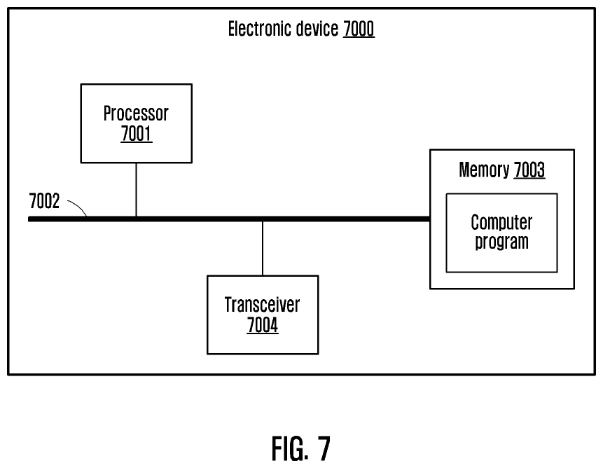

According to some embodiments, the electronic device may include a processor, and a transceiver and/or memory connected to the processor. The processor may be configured to execute the scene flow estimation and the AI network training method for scene flow estimation, which are described above. The configuration of the electronic device is described below with reference to FIG. 7.

FIG. 7 illustrates an example of an electronic device according to one or more example embodiments.

According to some embodiments, an electronic device 7000 may include a processor 7001 and a memory 7003. The processor 7001 and the memory 7003 may be connected via a bus 7002. For example, the electronic device 7000 may include a transceiver 7004 for transmitting and receiving data to and from other electronic devices. For example, the number of transceivers 7004 is not limited to one, and the structure of the electronic device 7000 is not limited to the example shown in FIG. 7. The electronic device 7000 may be a user terminal or a server.

The processor 7001 may be a central processing unit (CPU), a general-purpose processor, a digital signal processor (DSP), an application-specific integrated circuit (ASIC), or a field-programmable gate array (FPGA), or a programmable logic device, a transistor logic device, a hardware component, or any other combination. The processor 7001 may implement or execute each of the example logic blocks, modules, and circuits disclosed herein. The processor 7001 may also be any combination that implements computational functionality. For example, the processor 7001 may include a combination of one or more microprocessors or a combination of a DSP and a microprocessor.

The bus 7002 may include a path for transferring information between the processor 7001, the memory 7003, and other electronic devices. The bus 7002 may include, for example, a peripheral component interconnect (PCI) bus or an extended industry standard architecture (EISA) bus. For example, the bus 7002 may be classified as an address bus, a data bus, and a control bus. Although the bus 7002 is shown using a single bold line in FIG. 7 for ease of depiction, this is not intended to imply that there is only one bus or only one type of bus.

The memory 7003 may include, as non-limiting examples, a random-access memory (RAM), other types of dynamic storage devices capable of storing information and instructions, such as, an electrically erasable programmable read-only memory (EEPROM), a compact disc read-only memory (CD-ROM), other optical disk storage, optical disk storage (e.g., a compact disc, a laser disc, an optical disc, a digital multifunction disk, a Blu-ray disc, etc.), a magnetic disk storage medium, other magnetic storage devices, or any other computer-readable storage medium capable of carrying or storing program code in the form of instructions or data structures and accessible by a computer.

The memory 7003 may store a computer program. The computer program stored in the memory 7003 may be controlled by the processor 7001 to be executed thereby. For example, the processor 7001 may execute the computer program stored in the memory 7003 to implement the operations or steps of the methods described above according to example embodiments.

According to some embodiments, an electronic device described herein may further include a non-transitory computer-readable storage medium on which a computer program is stored. When executed by a processor of the electronic device, the computer program may implement an audio (or image) signal processing method described in any one of the appended claims.

The example embodiments described herein may be implemented using hardware components, software components, and/or combinations thereof. A processing device may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For the purpose of simplicity, the description of a processing device is used as singular; however, one skilled in the art will be appreciated that a processing device may include multiple processing elements and multiple types of processing elements. For example, a processing device may include multiple processors or a processor and a controller. In addition, different processing configurations are possible, such as, parallel processors.

The software may include a computer program, a piece of code, an instruction, or some combination thereof, to instruct or configure, independently or collectively, the processing device to operate as desired. The software and/or data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as ROM, RAM, flash memory (e.g., USB flash drives, memory cards, memory sticks, etc.), and the like. Examples of program instructions include both machine code, such as produced by a compiler, and files containing higher-level code that may be executed by the computer using an interpreter.

While some mathematical notation is used herein, such mathematical notation is not the direct subject of this disclosure. Rather, the mathematical notation is a convenient language for describing the configuration and operations of code/circuitry. The mathematical notation may be readily translated by an engineer into source code (and/or into high-level circuit specifications) that can be readily compiled (or reduced to hardware) by common tools. The mathematical notation could be replaced by equivalent textual description, but such description would be verbose and more difficult for engineers to understand and reduce to practice. In short, the mathematical notation used herein is a form of convenient notation well-understood by those of ordinary skill in the computing arts and serves as a blueprint for straightforward implementation of physical devices and physical instructions configured to function analogously to the mathematically described operations, functions, etc.

The computing apparatuses, the electronic devices, the processors, the memories, the image/depth sensors, the displays, the information output system and hardware, the storage devices, and other apparatuses, devices, units, modules, and components described herein with respect to FIGS. 1-7 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-7 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being in the disclosure.

What is claimed is:

1. A processor-implemented scene flow estimation method, comprising:
inputting a frame pair into an artificial intelligence (AI) network, and obtaining therefrom a motion embedding feature and a non-occluded-category label embedding feature corresponding to a target pixel in the frame pair; and
estimating a scene flow corresponding to the frame pair based on the motion embedding feature and the non-occluded-category label embedding feature,
wherein the frame pair comprises a first frame and a second frame,
wherein the first frame comprises a first color image and a first depth image and the second frame comprises a second color image and a second depth image,
wherein the non-occluded-category label embedding feature comprises category information of an object corresponding to a pixel pair in the frame pair,
wherein the pixel pair comprises a first pixel of the first frame and a second pixel of the second frame, the second pixel corresponding to the first pixel.

2. The scene flow estimation method of claim 1, wherein the estimating of the scene flow corresponding to the frame pair comprises:
obtaining a motion field corresponding to the frame pair;
obtaining the motion embedding feature and the non-occluded-category label embedding feature by inputting the motion field into the AI network;
fusing the motion embedding feature with the non-occluded-category label embedding feature to obtain a fused embedding feature;
obtaining a target motion field by updating the motion field based on the fused embedding feature; and
estimating the scene flow corresponding to the frame pair based on the target motion field.

3. The scene flow estimation method of claim 2, wherein the obtaining of the target motion field comprises:
determining a neighboring point set comprising pixels in the second frame that correspond to the target pixel in the first frame;
determining a matching level between the target pixel and the pixels in the neighboring point set, based on a fused embedding feature corresponding to the target pixel and based on fused embedding features of the respective pixels in the neighboring point set; and
obtaining the target motion field by updating the motion field based on the matching level.

4. The scene flow estimation method of claim 2, wherein the estimating of the scene flow corresponding to the frame pair comprises:
obtaining a weight that adjusts the motion field, based on similarity levels of similarity between pixels of the first color image; and
estimating the scene flow corresponding to the frame pair, based on the target motion field obtained by applying the weight to the motion field.

5. The scene flow estimation method of claim 4, wherein the obtaining of the weight comprises:
obtaining a first correlation between the pixels of the first color image by inputting the first color image into an attention encoder of the AI network; and
determining a first weight corresponding to the first color image based on the first correlation.

6. The scene flow estimation method of claim 5, wherein the obtaining of the weight comprises:
obtaining a second correlation between pixels of the second color image by inputting the color image comprised in the second frame into the attention encoder;
determining a second weight corresponding to the second color image based on the second correlation; and
obtaining a fused weight that adjusts the motion field by fusing the first weight with the second weight.

7. The scene flow estimation method of claim 2, wherein the obtaining of the motion embedding feature and the non-occluded-category label embedding feature comprises:
extracting, based on a feature encoder comprised in the AI network, a first frame feature from the first frame and a second frame feature from the second frame;
generating a correlation volume corresponding to the frame pair, based on a correlation between the first frame feature and the second frame feature;
extracting, based on a context encoder comprised in the AI network, a context feature and a hidden state corresponding to the first frame from the first frame data; and
obtaining the motion embedding feature and the non-occluded-category label embedding feature, by an operation of a convolutional gated recurrent unit (CGRU)-based update network comprised in the AI network, the operation based on the context feature, the hidden state, the motion field, and the correlation volume.

8. The scene flow estimation method of claim 1, further comprising:
training the AI network by iteratively performing a training operation on the AI network with a training set until a training end condition is satisfied.

9. The scene flow estimation method of claim 8, wherein the training set comprises a sample frame pair, and a ground truth (GT) scene flow value and a GT non-occluded-category label mask value corresponding to the sample frame pair,
wherein sample frame pair comprises a first sample frame comprising a first sample color image and a first sample depth image, and further comprises a second sample frame comprising a second sample color image and a second sample depth image,
wherein the GT non-occluded-category label mask value comprises category information corresponding to a sample pixel pair in the sample frame pair,
wherein the sample pixel pair comprises a first sample pixel in the first sample frame and a second sample pixel in the second sample frame, the first sample pixel corresponding to the second sample pixel.

10. The scene flow estimation method of claim 9, wherein the obtaining of the trained AI network by iteratively performing the training operation comprises:
obtaining a sample motion embedding feature and a sample non-occluded-category label embedding feature corresponding to the sample frame pair by applying the AI network to be trained to the sample frame pair;
obtaining an estimated scene flow value corresponding to the sample frame pair, based on the sample motion embedding feature and the sample non-occluded-category label embedding feature;
obtaining an estimated non-occluded-category label mask value corresponding to the sample frame pair, based on the sample non-occluded-category label embedding feature;
determining a first training loss, based on the predetermined GT scene flow value and the estimated scene flow value corresponding to the sample frame pair;
determining a second training loss, based on the predetermined GT non-occluded-category label mask value and the estimated non-occluded-category label mask value corresponding to the sample frame pair;
determining a combined training loss based on the first training loss and the second training loss; and
adjusting a model parameter of the AI network to be trained, based on the combined training loss.

11. The scene flow estimation method of claim 10, wherein the obtaining of the estimated non-occluded-category label mask value corresponding to the sample frame pair, based on the sample non-occluded-category label embedding feature comprises:
determining an average non-occluded-category label feature of pixels corresponding to a category comprised in the sample frame pair, based on the GT non-occluded-category label mask value and the sample non-occluded-category label embedding feature; and
based on a difference between a sample non-occluded-category label embedding feature corresponding to a pixel comprised in the first sample frame and an average non-occluded-category label feature of pixels corresponding to a category to which the pixel comprised in the first sample frame belongs, obtaining the estimated non-occluded-category label mask value corresponding to the category of the pixel comprised in the first sample frame data.

12. The scene flow estimation method of claim 9, wherein the GT non-occluded-category label mask value corresponding to the sample frame pair is determined based on:
obtaining an object instance segmentation result for object instances comprised in the sample frame pair;
determining a first optical error between matched pixels of a pixel pair in the sample frame pair, based on the GT scene flow value corresponding to the sample frame pair;
determining a GT non-occluded-category label mask value corresponding to each of the object instances comprised in the sample frame pair, based on the first optical error and the object instance segmentation result; and
obtaining the GT non-occluded-category label mask value corresponding to the sample frame pair, based on the GT non-occluded-category label mask value corresponding to each of the object instances comprised in the sample frame pair.

13. The scene flow estimation method of claim 12, wherein the GT non-occluded-category label mask value corresponding to the sample frame pair is determined based on:
obtaining a GT motion field value corresponding to the sample frame pair;
determining a second optical error and a depth error between the matched pixels of the pixel pair in the sample frame pair, based on the GT motion field value;
determining a GT non-occluded-category label mask value corresponding to a non-occluded background region of the sample frame pair, based on the second optical error and the depth error; and
obtaining the GT non-occluded-category label mask value corresponding to the sample frame pair by fusing the GT non-occluded-category label mask value corresponding to the non-occluded background region and the GT non-occluded-category label mask value corresponding to each of the object instances comprised in the sample frame pair.

14. A non-transitory computer-readable storage medium storing instructions that, when executed by a processor, cause the processor to perform the scene flow estimation method of claim 1.

15. A scene flow estimation device, comprising:
one or more processors configured to input a frame pair into an artificial intelligence (AI) network and obtain a motion embedding feature and a non-occluded-category label embedding feature corresponding to the frame pair, and estimate a scene flow corresponding to the frame pair based on the motion embedding feature and the non-occluded-category label embedding feature,
wherein the frame pair comprises a first frame and a second frame, the first frame comprising a first color image and a first depth image, and the second frame comprising a second color image and a second depth image,
wherein the non-occluded-category label embedding feature comprises category information of an object corresponding to a pixel pair in the frame pair, and
wherein the pixel pair comprises a first pixel of the first frame and a second pixel of the second frame, the first pixel corresponding to the second pixel.

16. The scene flow estimation device of claim 15, wherein the one or more processors are further configured to:
obtain a motion field corresponding to the frame pair;
obtain the motion embedding feature and the non-occluded-category label embedding feature corresponding to the frame pair by inputting the motion field into the AI network;
fuse the motion embedding feature with the non-occluded-category label embedding feature to obtain a fused embedding feature;
obtain a target motion field by updating the motion field based on the fused embedding feature; and
estimate the scene flow corresponding to the frame pair based on the target motion field.

17. The scene flow estimation device of claim 16, wherein the one or more processors are configured to:
determine a neighboring point set comprising pixels in the second frame that correspond to a target pixel in the first frame;
determine a matching level between the target pixel and pixels comprised in the determined neighboring point set based on a fused embedding feature corresponding to the target pixel and fused embedding features of the pixels in the neighboring point set; and
obtain the target motion field by updating the motion field based on the matching level.

18. The scene flow estimation device of claim 16, wherein the one or more processors are further configured to:
obtain a weight that adjusts the motion field based on a similarity level between pixels in the first color image; and
estimate the scene flow corresponding to the frame pair based on the target motion field obtained by applying the weight to the motion field.

19. The scene flow estimation device of claim 18, wherein the one or more processors are further configured to:
obtain a first correlation between the pixels of the first color image by inputting the color first image into an attention encoder of the AI network; and
determine a first weight corresponding to the first color image based on the first correlation.

20. The scene flow estimation device of claim 19, wherein the one or more processors are further configured to:
obtain a second correlation between pixels of the second color image by inputting the second color image into the attention encoder;
determine a second weight corresponding to the second color image based on the second correlation; and
obtain a fused weight that adjusts the motion field by fusing the first weight and the second weight.
